(19) United States
(12) Patent Application Publication
(10) Pub. No.: US 2006/0047573 A1
(43) Pub. Date: Mar. 2, 2006

(54) Coupon and sweepstakes dispensing system and method of use

(75) Inventors: Robert E. Mitchell, Pleasant Prarie, WI (US); Charles P. Brown, Chicago, IL (US); Thomas L. Cetta, Racine, WI (US)

Correspondence Address: Lesavich High-Tech Law Group, P.C., Suite 325, 39 S. LaSalle Street, Chicago, IL, 60603, US

(73) Assignee: True Resources, LLC, Kenosha, WI (US)

(21) Appl. No.: 11/213,248

(22) Filed: Aug. 26, 2005

Related U.S. Application Data
(60) Provisional application No. 60/604,524, filed on Aug. 26, 2004.

(51) Int. Cl. G06Q 30/00

(52) U.S. Cl. 705/14

(57) ABSTRACT

A coupon and sweepstakes dispensing system and method of use. The method and system include an electronic kiosk at which a coupon is purchased by a customer. The coupon includes a free sweepstakes entry. The coupon includes a redemption value N-times the purchase price. The free sweepstakes entry provides a chance to win items with redemption values M-time purchase price of the coupons. The methods and system described herein help retailers and advertisers reach consumers with their product offers. Shoppers select to purchase coupons for a nominal fee for the time saved, convenience, value and variety, plus automatically, are entered into a free sweepstakes that can bring cash or credit at the retail establishment where they are shopping.

### CROSS REFERENCES TO RELATED APPLICATIONS

This application claims priority to U.S. Provisional Patent Application No. 60/604,524, filed Aug. 26, 2004, the contents of which are incorporated by reference.

### FIELD OF THE INVENTION

This invention relates to electronic kiosks. More specifically, it relates to a coupon and sweepstakes dispensing system and method of use.

### BACKGROUND OF THE INVENTION

As is known in the art, a coupon is “a printed advertisement used to obtain a discount on merchandise.” Many historians have written that some of the first coupons were first used in about 1894 by druggists who were selling Coca-Cola®. Such druggists gave out handwritten tickets for a free glass of this new fountain drink. A year later, in 1895, C. W. Post distributed one of the first grocery coupons worth one cent towards his new health cereal, Grape Nuts. By the 1930's coupons were a staple in the American households because of the depression. Needing to save money in any fashion possible, households became dependant on clipping coupons and saving money on their weekly grocery bills. Supermarkets springing up across the country and coupon clearinghouses helped drive the coupon craze through the 1940's and 50's. By 1965, about half of all Americans were using coupons. By 2002, shoppers were saving about $3 billion annually by redeeming about 3.8 billion coupons on a variety of product categories. Today, it is estimated over 79% of all the people in the U.S. use coupons. This truly makes coupon use a part of American life.

Coupons help introduce consumer products, promote brand names, increase unit sales in short bursts, impress consumers and retailers alike with their offers, and help capitalize on seasonal awareness. It is estimated that nearly 80% of shoppers would use coupons if given the opportunity according to the Coupon Council of the Promotional Marketing Association. Consumer Product Companies invest nearly $6 billion per year in creating, marketing and distributing over 300 billion coupons in the U.S. alone.

There are a number of problems associated with using coupons. One problem is that coupons are time consuming to use. The time problems associated with coupons include, for example: (1) planning what to shop for/where; (2) finding the coupons that could be used; (3) clipping the coupons; (4) organizing the coupons and; (5) remembering to bring the coupons along to the proper store. This about 20 minutes to 120 minutes per trip according to the Coupon Council of the PMA. These problems contribute to redemption rates being as low as 1%.

Another problem is that most of today's coupons are printed on newspaper and come from sources such as Free Standing Inserts (FSIs) and Direct Mail Packets (DMPs) These FSIs and DMPs are expensive to produce and distribute for retailers.

Another problem is that newspaper subscription rates have been steadily shrinking. Sunday paper circulation with all its supplements has been also steadily shrinking making coupons harder to find and less available.

Many retailers have turned away from coupons to sweepstakes to promote their products and services. Consumer Product Marketers (CPM) have been using sweepstakes and contests for 15-20 years to promote their products and services. Giving consumers a chance to win cash or prizes increases their excitement and thus the CPM market share and drives profits higher. Some of the most popular sweepstakes that merchandisers and retailers use include, for example, (a) Instant win games with game pieces delivered on-pack or in-pack; (b) Match game pieces against displays or web site to win instantly; (c) Automatic entry with purchase via coupon or rebate redemption or order form; (d) Pre-selected winning number sweepstakes; (e) Entry with proof of purchase requested: Universal Product Code (UPC) number, serial number, or style number; (f) Survey entry forms to build database; (g) Quiz entry forms to test audience's knowledge of the product or service; and (h) Skill contest to generate publicity or require use of the sponsor's products.

Probably one of the most famous sweepstakes is the McDonald's® Monopoly® Promotion that has typically been run twice a year. Many well known Fortune 500 companies have been using sweepstakes effectively and will continue doing so. CPMs, wanting to be effective in driving sales, favor the sweepstakes method because of demonstrated consumer excitement. Merchandisers sell more products during these promotions. Sweepstakes upgrade the customer to buy more profitable or more items using the compelling nature of the sweepstakes. Shoppers seek out companies that offer sweepstakes to enhance the value of the product being purchased. Merchandisers and retailers continue to seek out new and exciting sweepstakes to offer the public in conjunction with their products.

There are several problems associated with using sweepstakes to promote products and services. One problem is sweepstakes promotions have been costly, prohibiting most advertisers from participating. Another problem is that most sweepstake promotions must be carefully planned and distributed to prevent fraud and ensure only the selected number of winners are identified. Another problem is that most states closely regulate sweepstakes and specifically state what must be done to qualify as a sweepstakes in their particular jurisdiction to avoid running afoul of gaming or gambling laws.

There have been attempts to solve some of the problems associated with using coupons and sweepstakes together to promote goods and services. For example, U.S. Pat. No. 6,340,179, entitled, “Advertising materials and method for cooperative promotions” that issued to Robert E. Mitchell teaches advertising materials are provided for cooperative promotions. The materials consist of a set of coupons and a promotional piece or flare. Each coupon includes a back face with award structure information printed thereon and a front face with product advertising printed thereon. Each coupon entitles its purchaser to a substantial discount on a product, which discount exceeds the purchase price of the coupon. Multiple break-open windows are formed in the coupon and are movable between closed and open positions respectively concealing and revealing outcome-determining indicia. The indicia comprise symbol combinations and identify respective coupons as either losers or winners entitled to pre-determined awards. A cooperative promotional method utilizing the advertising materials is also disclosed.

U.S. Pat. No. 4,882,675, entitled “Paperless system for distributing, redeeming and clearing merchandise coupons” that issued to Nichtberger, et al. teaches Cents-off merchandise coupons are distributed and redeemed immediately and electronically. An electronic display of coupons valid for use in a particular store is presented to customers in that store. When a customer makes a selection of coupons from the display, the selection is recorded. The customer is subsequently identified at a store checkout station as the one who made the selection. In a preferred embodiment, the identification is made by scanning a special card adapted for use with the system. The items purchased in the store by the customer are recorded, and any matches between the coupons selected and the items purchased are determined electronically. The customer is immediately credited in accordance with the terms of the matched coupons. Redeemed coupons are periodically cleared electronically.

U.S. Pat. No. 5,708,782, entitled “Method and apparatus for dispensing discount coupons,” issued to Larson, et al. teaches the present invention resides in apparatus, and software, and a related method for selecting, printing, and dispensing a redeemable discount coupon and other offerings in response to the taking of or upon the return of a cart to a electronic coupon dispensing terminals. A computerized kiosk, updated by a remote command center, is located at the entrance of the corral. Customers receive a key at the check out counter to be used to access the dispenser for the selection of discount coupons. As the cart is replaced in the corral, the system is activated and the customer selects from a touch screen monitor and a dispenser prints and issues a manufacturer's coupon. Statistical information is gathered by the computer and relayed to the store CPU. Maintenance requirements are also relayed to the store CPU.

U.S. Pat. No. 6,076,068, entitled “Coupon delivery system” that issued to DeLupa et al. teaches a computer-implemented method and apparatus for generating coupons to provide discounts for purchases includes providing a computer-based kiosk at a retail establishment such as a grocery store. A customer identification of a household is received at the kiosk. The kiosk outputs a series of targeted coupons which have been assigned to the individual household on the basis of at least one attribute of that household. Images of coupons may be formatted “on the fly” from parameters set forth in a coupon record. The system may further include an enhancement system which provides tools for enhancing the coupon offer data by designating particular offers as either a targeted coupon offer assigned to individual households as a function of purchases by that household or a mandatory coupon which is assigned to substantially all households. The kiosk may additionally print personalized messages by substituting for a keyword a value derived from an attribute of the identified household and outputting the graphic image of the personalized message.

U.S. Pat. No. 6,619,915, entitled “electronic coupon system and method of processing electronic coupon card for storage and redemption” issued to Thaxton, et al. teaches an electronic coupon system and a method of processing electronic coupons are provided utilizing a coupon card on which data representing selected coupons may be stored for subsequent redemption at a point-of-sale terminal. In accordance with one embodiment of the present invention, an electronic coupon system is provided including, a coupon card, an in-store kiosk, a point-of-sale terminal, a host computer, and a coupon data processor. The host computer is in communication with the in-store kiosk and the point-of-sale terminal. The in-store kiosk includes a user interface and a coupon card interface. The point-of-sale terminal includes a transaction data interface and a point-of-sale coupon card interface. The coupon data processor is programmed to correlate the transaction data with the coupon data read from the coupon card by the coupon card interface and to reduce the product sale price by an amount indicated in the coupon data.

U.S. Published patent application No. 20010051894, entitled “Internet Coupon Selection System” that was filed by Delapa teaches a merchandising system for generating product discount coupons preselected by each participating consumer. The process allows the consumer to select the coupons at home through a remote communication site, such as an Internet site. The selections are then electronically transferred to a specified store also chosen by the consumer. Upon arrival at the designated store location, the consumer receives the selected coupons, which are printed at the store by a kiosk or other form of printer. These coupons are immediately redeemable by the consumer during the current shopping trip upon purchase of the corresponding items.

U.S. Published patent application No. 20040084892, entitled, “Advertising materials and method for cooperative promotions” that was filed by Robert E. Mitchell teaches Advertising materials are provided for cooperative promotions. The materials consist of a set of coupons and a promotional piece or flare. Each coupon includes a back face with award structure information printed thereon and a front face with product advertising printed thereon. Each coupon entitles its purchaser to a substantial discount on a product, which discount exceeds the purchase price of the coupon. Multiple break-open windows are formed in the coupon and are movable between closed and open positions respectively concealing and revealing outcome-determining indicia. The indicia comprise symbol combinations and identify respective coupons as either losers or winners entitled to pre-determined awards. A cooperative promotional method utilizing the advertising materials is also disclosed.

Thus, it is desirable to provide a system and method that combines coupons and sweepstakes. Such a system and method should provide benefits to both retailers and shoppers.

### SUMMARY OF THE INVENTION

In accordance with preferred embodiments of the present invention, some of the problems associated with combining coupons and sweepstakes are overcome. A coupon and sweepstakes dispensing system and method of use are presented.

The method and system include an electronic kiosk at which a coupon sweepstakes object is selected and purchased by a customer. The coupon sweepstakes object includes a coupon redemption value greater than the purchase price and a free sweepstakes entry with a potential winning redemption value much greater than the purchase price of the coupon. The methods and system described herein help retailers and advertisers reach consumers with their product offers. Shoppers select to purchase coupons by paying a nominal fee for the time saved, convenience, value and variety, plus automatically, are entered into a free sweepstakes that can award cash or credit at the retail establishment where they are shopping.

The foregoing and other features and advantages of preferred embodiments of the present invention will be more readily apparent from the following detailed description. The detailed description proceeds with references to the accompanying drawings.

### BRIEF DESCRIPTION OF THE DRAWINGS

Preferred embodiments of the present invention are described with reference to the following drawings, wherein:

FIG. 1 is a block diagram illustrating a coupon and sweepstakes dispensing system;

FIG. 2A is a block diagram illustrating an exemplary coupon sweepstakes object dispensed from the coupon and sweepstakes dispensing system of FIG. 1;

FIG. 2B is a block diagram illustrating another exemplary coupon sweepstakes object dispensed from the coupon sweepstakes dispensing system of FIG. 1;

FIG. 3 is a flow diagram illustrating a method for providing a coupon sweepstakes object;

FIG. 4 is a flow diagram illustrating a method for providing a coupon sweepstakes object;

FIG. 5 is a block diagram of a set of main participants for a cooperative promotional advertising method; and

FIGS. 6A and 6B are a flow diagram illustrating a method for co-promotional advertising using coupon sweepstakes objects;

FIG. 7 is a flow diagram illustrating a method for co-promotional advertising using coupon sweepstakes objects;

FIG. 8 is a flow diagram illustrating a method for providing a coupon sweepstakes object; and

FIG. 9 is a block diagram illustrating an exemplary data flow for the electronic kiosk.

### DETAILED DESCRIPTION OF THE INVENTION

Coupon Sweepstakes Dispensing System

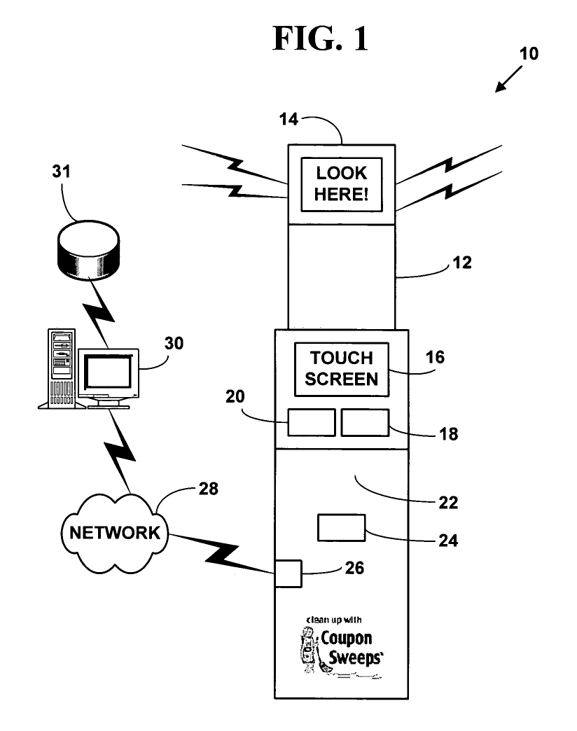

FIG. 1 is a block diagram illustrating a coupon and sweepstakes dispensing system 10. The system 10 includes, but is not limited to, an electronic kiosk 12 that comprises a customer attraction component 14, a touch screen component 16, a card reader component 18, a currency input component 20, a printing component 22 including a printed coupon and sweepstakes dispensing component 24, a network interface component 26 for connecting the electronic kiosk 12 to a communications network 28 including one or more servers 30 (one of which is illustrated). The one or more servers 30 include network interfaces (e.g., web-site interfaces) accessible by a customer via the communications network 28. The electronic kiosk 12 and servers 30 may also include one or more local or remotely accessible databases 31 (not illustrated for the electronic kiosk 12). However, the present invention is not limited to such an embodiment and more, fewer or other components can also be used to practice the invention.

In another embodiment, the electronic kiosk 12 is implemented as a virtual electronic kiosk 12 that resides on server 30 and is accessible by the communications network 28 (e.g., via a web-site on the Internet 28). In such an embodiment, a customer accesses the virtual electronic kiosk 12 via a network device connected to the communications network 28 such as a computer, personal digital/data assistant (PDA), mobile phone, non-mobile phone, two-way pager, Internet appliance or other network devices. In such an embodiment, the virtual electronic kiosk 12 includes a graphical user interface (GUI) and allows payment to be accepted electronically (e.g., with a credit card number, debit card number, PAYPAL, electronic check payment, etc.). In such an embodiment a customer can select, purchase and electronically print coupons and a free sweep stakes entry on a printer attached to their network device. The customer can also select coupons and electronic purchase coupons and print them at a later time on an actual electronic kiosk 12 in a store from a customer profile stored on the server 30 or on a user card.

Preferred embodiments of the present invention includes devices and interfaces that are compliant with all or part of standards proposed by the Institute of Electrical and Electronic Engineers (IEEE), International Telecommunications Union-Telecommunication Standardization Sector (ITU), European Telecommunications Standards Institute (ETSI), Internet Engineering Task Force (IETF), U.S. National Institute of Security Technology (NIST), American National Standard Institute (ANSI), Wireless Application Protocol (WAP) Forum, Data Over Cable Service Interface Specification (DOCSIS) Forum, Bluetooth Forum, ADSL Forum, Association of Coupon Professional, Coupon Council of the Promotional Marketing Association, Grocery Manufacturers Association (GMA), GS1, National Association of Convenience Stores (NACS), National Association of Truck Stop Owners (NATSO), National Automatic Merchandising Association (NAMA), National Grocers Association, National Retailer Federation, Promotional Marketing Association, or United States Standard Products and Services Codes. However, network devices and interfaces based on other standards could also be used.

IEEE standards can be found on the World Wide Web at the Universal Resource Locator (URL) “www.ieee.org.” The ITU, (formerly known as the CCITT) standards can be found at the URL “www.itu.ch.” ETSI standards can be found at the URL “www.etsi.org.” IETF standards can be found at the URL “www.ietf.org.” The NIST standards can be found at the URL “www.nist.gov.” The ANSI standards can be found at the URL “www.ansi.org.” The DOCSIS standard can be found at the URL “www.cablemodem.com.” Bluetooth Forum documents can be found at the URL “www.bluetooth.com.” WAP Forum documents can be found at the URL “www.wapforum.org.” ADSL Forum documents can be found at the URL “www.adsl.com.” Association of Coupon Professional documents can be found at the URL “www.couponpros.com.” Coupon Council of the Promotional Marketing Association documents can be found at the URL “www.couponmonth.com.” Grocery Manufacturers Association can be found at the URL “www.gmabrands.com.” GSI documents can be found at the URL “www.gslus.org/gslus.htm.” National Association of Convenience Stores (NACS) documents can be found at the URL “cstorecentral.com.” National Association of Truck Stop Owners documents can be found at the URL “ww.natso.com.” National Automatic Merchandising Association documents can be found at the URL “www.vending.org.” National Grocers Association documents can be found at the URL “www.nationalgrocers.org.” National Retailer Federation, Promotional Marketing Association documents can be found at the URL “www.nrf.com.” United States Standard Products and Services Codes documents can be found at the URL “www.unspsc.org.”

The electronic kiosk 12 is typically placed in a highly visible location (e.g., near a front door location, etc.) in a retail or convenience store (e.g., grocery store, convenience store, home improvement store, etc.) or outside a convenience store (e.g., at a gas pump, etc.).

In one embodiment, the electronic kiosk 12 includes a supermarket storefront kiosk. The supermarket storefront kiosk is designed to sit at the front of the store near the entrances. It has an attraction loop that is played on the customer attraction component 14 designed for the supermarket environment. It accepts payment via the currency input component 20 (e.g., $1, $5, $10, $20, $50, etc. dollar bills and coins) and card reader component 18. It prints Coupon Sweepstakes objects 32, with coupons selected buy a customer via the touch screen component 16 and a sweepstakes entry, when the transaction is complete. Sweepstakes entries have printed and bar-coded entry numbers. In one embodiment, the Coupon Sweepstakes objects 32 indicate whether a prize was won. In another embodiment, the Coupon Sweepstakes objects 32 do not indicate whether a prize was won so a customer must take the Coupon sweepstakes object 32, 33 to a supermarket cashier to determine if the customer is a winner.

In another embodiment, the electronic kiosk 12 includes a convenience store at-pump kiosk. The convenience store at-pump kiosk is designed to sit at a pump island at convenience store gas stations. It has an attraction loop that is played on the customer attraction component 14 designed for convenience store gas pumps. In one embodiment, the convenience store at-pump kiosk accepts payment only via the card reader component 18 to prevent theft of currency. In another embodiment, the convenience store at-pump kiosk accepts payment via the card reader component 18 and the currency input component 24. The convenience store at-pump kiosk prints Coupon Sweepstakes objects 32, with bar-coded sweepstakes ticket along with coupons selected by a customer. The sweepstakes entries have printed and bar-coded entry numbers, but do not indicate whether or not a prize was won. Customer must go into the convenience store to determine if sweepstake entry was a winner. At-pump kiosks communicate via a wired or wireless network interface component 26 to an in-store server 30.

In another embodiment, the electronic kiosk 12 includes a convenience in-store kiosk. The convenience store in-store kiosk is designed to sit inside a convenience store. It has an attraction loop that is played on the customer attraction component 14 designed for convenience stores. In one embodiment, the convenience in-store kiosk accepts payment only via the card reader component 18 to prevent theft of currency. In another embodiment, the convenience in-store kiosk accepts payment via the card reader component 18 and the currency input component 24. The convenience in-store kiosk prints Coupon Sweepstakes objects 32, with a bar-coded sweepstakes entry along with coupons selected by a customer. The sweepstakes entry has printed and bar-coded entry numbers, that indicate whether or not a prize was won. Convenience store in-store kiosks communicate via a wired or wireless network interface component 26 to an in-store server 30.

In another embodiment, the convenience in-store kiosk includes barcode reader in the card reader component 18 or a separate barcode reader component that reads Coupon Sweepstakes objects 32 printed by convenience store at-pump kiosks, prints redeemable ticket for winners, displays sorry message for losers and also prints winning sweepstakes entry immediately when purchased in-store.

In another embodiment, the electronic kiosk 12 automatically indicates that a customer is a sweepstakes winner and allows the customer an option to collect the sweepstakes prize as a cash value on gift card or loyalty card for the store, for another store or for the same or another retail chain. In such an embodiment, the gift card or loyalty card is dispensed from the card reader component 18.

The customer attraction component 14 includes, for example, plural flashing lights, a display screen for displaying an audio/visual recording, or other single media or multi-media components used to attract customers to the electronic kiosk 12. The customer attraction component 14 may also be used to display help information to instruct a customer on how to use the electronic kiosk 12. The customer attraction component 14 may also be used to display advertising information from one or more advertisers.

The touch screen component 16 includes a graphical user interface (GUI) that is used to graphically display information and accept inputs from a customer, via a customers touch. The GUI includes plural icons allowing for selection of functionality of the system visually. For example, when placed in a grocery store, the GUI may provide graphical icons for plural grocery products such as milk, cereal, etc. that a commonly purchased by shoppers. When placed at a pump or in a convenience store, the GUI may provide graphical icons for plural convenience store items such as liquor, cigarettes, sandwiches, fountain drinks, milk, etc. The touch screen component 16 may also be used to display help information to instruct a customer on how to use the electronic kiosk 12 and may also be used to display advertising information from one or more advertisers.

The electronic kiosk 12 includes one or more central processing units (CPUs) or other processors and includes one or more memories. In one embodiment, the one or more memories include one or more programs with plural instructions for generating selected coupons and random numbers and other data used to manage a sweepstakes included on the Coupon Sweepstakes objects 32 printed and dispensed by the electronic kiosk 12.

In another embodiment, the one or more memories include plural instructions received from the one or more servers 30 via the communications network 28 for generating selected coupons and random numbers and other data used to manage a sweepstakes included on the Coupon Sweepstakes objects 32 printed and dispensed by the electronic kiosk 12.

The card reader component 18 includes a card reader to accept credit cards, debit cards, retail cards, gift cards, store loyalty cards and other customer cards. The card reader component 18 is capable of reading magnetic information, optical information, (e.g., Universal Product Codes (UPC) or bar-coded information, etc.) alphanumeric information (e.g., serial numbers, etc.) radio frequency identifier (RFID) information and other types of information encoded on a card inserted into the card reader component. In another embodiment, the card reader component 18 can also accept checks.

The currency input component 20 is used to accept paper currency and coin currency (e.g., paper money and coins). In another embodiment of the invention, the card reader component 18 and the currency input component 20 are combined into one component.

The printing component 22 includes a printer and paper for dispensing paper coupons including sweepstakes information as is described below. In one embodiment of the invention, the printing component 22 includes a thermal printer. However, the present invention is not limited to thermal printers and other types of printers (e.g., impact, ink-jet, laser-jet, etc.) can also be used. In one embodiment of the invention, the printing component 22 includes at least two rolls of printer paper that are individually selectable by the printer. In one embodiment, the printing component 22 prints onto double-sided coupons with a sweepstakes entry and sweepstakes information as is described below. In another embodiment, the printing component 22 prints a single-side coupon with a sweepstakes entry and sweepstakes information. The printed coupon and sweepstakes dispensing component 24 dispenses coupons with sweepstakes information included thereon to a customer.

The network interface component 26 is used for connecting the electronic kiosk 12 to a communications network 28 including one or more servers 30 (one of which is illustrated). The network interface component 26 includes a wired and/or a wireless network interface. The one or more servers 30 may be used to provide coupon and/or sweepstakes information and collect data from and send data to the electronic kiosk 12.

The communications network 28 includes, but is not limited to, the Internet, an intranet, a wired Local Area Network (LAN), a wireless LAN (WiLAN), a Wide Area Network (WAN), a Metropolitan Area Network (MAN), Public Switched Telephone Network (PSTN), Cable Television (CATV) and other types of communications networks 18 providing voice, video and data communications.

The communications network 28 may include one or more gateways, routers, bridges, or switches. As is known in the art, a gateway connects computer networks using different network protocols and/or operating at different transmission capacities. A router receives transmitted messages and forwards them to their correct destinations over the most efficient available route. A bridge is a device that connects networks using the same communications protocols so that information can be passed from one network device to another. A switch is a device that filters and forwards packets between communication network segments. A switch typically operates at a data link layer (layer 2) and sometimes a network layer (layer 3) of the OSI Reference Model and therefore supports virtually any wired or wireless data packet protocol.

The communications network 28 may include one or more web-sites accessible by customer to send and receive information useable by the electronic kiosk 12. For example, the one or more web-sites may allow a customer to view and pre-select one or more coupons from a list of available coupons. The list is saved on a customer card or in a customer profile. The customer card or customer profile is then used by the electronic kiosk 12 to retrieve and print the pre-selected coupons for the customer.

The communications network 28 includes, but is not limited to data networks using the Transmission Control Protocol (TCP), User Datagram Protocol (UDP), Internet Protocol (IP) and other data protocols.

As is know in the art, TCP provides a connection-oriented, end-to-end reliable protocol designed to fit into a layered hierarchy of protocols which support multi-network applications. TCP provides for reliable inter-process communication between pairs of processes in network devices attached to distinct but interconnected networks. For more information on TCP see Internet Engineering Task Force (ITEF) Request For Comments (RFC)-793, the contents of which are incorporated herein by reference.

As is know in the art, UDP provides a connectionless mode of communications with datagrams in an interconnected set of computer networks. UDP provides a transaction oriented datagram protocol, where delivery and duplicate packet protection are not guaranteed. For more information on UDP see IETF RFC-768, the contents of which incorporated herein by reference.

As is known in the art, IP is an addressing protocol designed to route traffic within a network or between networks. IP is described in IETF Request For Comments (RFC)-791, the contents of which are incorporated herein by reference. However, more fewer or other protocols can also be used on the communications network 28 and the present invention is not limited to TCP/UDP/IP.

The communications network 28 may also include portions of a PSTN or CATV network that connects the electronic kiosk 12 via one or more twisted pairs of copper wires, coaxial cable, fiber optic cable, other connection media or other connection interfaces with corresponding wired connection protocols (e.g., DSL, ADSL, ISDN, etc.) The PSTN is any public switched telephone network provided by AT&T, GTE, Sprint, MCI, SBC, Verizon and others. The CATV network is any cable television provided by Time-Warner, Comcast and others.

The network interface component 26 includes security features. The network interface component includes security and encryption functionality. As is known in the art, “encryption” is a process of encoding data to prevent unauthorized access, especially during data transmission. Encryption is usually based on one or more secret keys, or codes, that are essential for decoding, or returning the data to its original readable form.

There are two main types of encryption: “asymmetric” encryption (also called public-key encryption) and “symmetric” encryption. Asymmetric encryption is cryptographic system that uses two keys—a “public key” known to everyone and a “private or secret key” known only to the recipient of the message. “Symmetric encryption” is a type of encryption where the same key is used to encrypt and decrypt the message.

The are encryption protocols that have been specifically designed for wireless network interfaces. The Wireless Encryption Protocol (“WEP”) (also called “Wired Equivalent Privacy”) is a security protocol for WiLANs defined in the IEEE 802.11b standard. WEP is cryptographic privacy algorithm, based on the Rivest Cipher 4 (RC 4) encryption engine, used to provide confidentiality for 802.11b wireless data.

As is known in the art, RC4 is cipher designed by RSA Data Security, Inc. of Bedford, Mass., which can accept encryption keys of arbitrary length, and is essentially a pseudo random number generator with an output of the generator being XORed with a data stream to produce encrypted data.

The IEEE 802.11 Working Group is working on a security upgrade for the 802.11 standard called “802.11i.” This supplemental draft standard is intended to improve WiLAN security. It describes the encrypted transmission of data between systems 802.11X WiLANs. It also defines new encryption key protocols including the Temporal Key Integrity Protocol (TKIP). The IEEE 802.11i draft standard, version 4, completed Jun. 6, 2003, is incorporated herein by reference.

The 802.11i is based on 802.1x port-based authentication for user and device authentication. The 802.11i standard includes two main developments: Wi-Fi Protected Access (“WPA”) and Robust Security Network (“RSN”).

WPA uses the same RC4 underlying encryption algorithm as WEP. However, WPA uses TKIP to improve security of keys used with WEP. WPA keys are derived and rotated more often than WEP keys and thus provide additional security. WPA also adds a message-integrity-check function to prevent packet forgeries.

RSN uses dynamic negotiation of authentication and selectable encryption algorithms between wireless access points and wireless devices. The authentication schemes proposed in the draft standard include Extensible Authentication Protocol (“EAP”). One proposed encryption algorithm is an Advanced Encryption Standard (“AES”) encryption algorithm.

Dynamic negotiation of authentication and encryption algorithms lets RSN evolve with the state of the art in security, adding algorithms to address new threats and continuing to provide the security necessary to protect information that Wireless LANs (WiLANs) carry.

The NIST developed a new encryption standard, the Advanced Encryption Standard (“AES”) to keep government information secure. AES is intended to be a stronger, more efficient successor to Triple Data Encryption Standard (“3DES”). More information on NIST AES can be found at the URL www.nist.gov/aes.

As is known in the art, DES is a popular symmetric-key encryption method developed in 1975 and standardized by ANSI in 1981 as ANSI X.3.92, the contents of which are incorporated by reference. As is known in the art, 3DES is the encrypt-decrypt-encrypt (“EDE”) mode of the DES cipher algorithm. 3DES is defined in the ANSI standard, ANSI X9.52-1998, the contents of which are incorporated by reference. DES modes of operation are used in conjunction with the NIST Federal Information Processing Standard (“FIPS”) for data encryption (FIPS 46-3, October 1999), the contents of which are incorporated by reference.

DES, 3DES and other encryption techniques can be used in the Cipher Block Chaining Mode (CBC). CBC introduces a dependency between data blocks which protects against fraudulent data insertion and replay attacks. In addition, CBC ensures that consecutive repetitive blocks of data do not yield identical cipher text.

The NIST approved a FIPS for the AES, FIPS-197. This standard specified “Rijndael” encryption as a FIPS-approved symmetric encryption algorithm that may be used by U.S. Government organizations (and others) to protect sensitive information. The NIST FIPS-197 standard (AES FIPS PUB 197, November 2001) is incorporated herein by reference.

The NIST approved a FIPS for U.S. Federal Government requirements for information technology products for sensitive but unclassified (“SBU”) communications. The NIST FIPS Security Requirements for Cryptographic Modules (FIPS PUB 140-2, May 2001) is incorporated by reference.

As is known in the art, RSA is one example of a public key encryption system which can be used both for encrypting messages and making digital signatures. The letters RSA stand for the names of the inventors: Rivest, Shamir and Adleman. For more information on RSA, see U.S. Pat. No. 4,405,829, now expired, incorporated herein by reference.

As is known in the art, “hashing” is the transformation of a string of characters into a usually shorter fixed-length value or key that represents the original string. Hashing is used to index and retrieve items in a database because it is faster to find the item using the shorter hashed key than to find it using the original value. It is also used in many encryption algorithms.

Secure Hash Algorithm (SHA), is used for computing a secure condensed representation of a data message or a data file. When a message of any length <2⁶⁴ bits is input, the SHA-1 produces a 160-bit output called a “message digest.” The message digest can then be input to other security techniques such as encryption, a Digital Signature Algorithm (DSA) and others which generates or verifies a security mechanism for the message. SHA-512 outputs a 512-bit message digest. The Secure Hash Standard, FIPS PUB 180-1, Apr. 17, 1995, is incorporated herein by reference.

Message Digest-5 (MD-5) takes as input a message of arbitrary length and produces as output a 128-bit “message digest” of the input. The MD5 algorithm is intended for digital signature applications, where a large file must be “compressed” in a secure manner before being encrypted with a private (secret) key under a public-key cryptosystem such as RSA. The IETF RFC-1321, entitled “The MD5 Message-Digest Algorithm” is incorporated here by reference.

As is known in the art, providing a way to check the integrity of information transmitted over or stored in an unreliable medium such as a wireless network is a prime necessity in the world of open computing and communications. Mechanisms that provide such integrity check based on a secret key are called “message authentication codes” (MAC). Typically, message authentication codes are used between two parties that share a secret key in order to validate information transmitted between these parties.

Keyed Hashing for Message Authentication Codes (HMAC), is a mechanism for message authentication using cryptographic hash functions. HMAC is used with any iterative cryptographic hash function, e.g., MD5, SHA-1, SHA-512, etc. in combination with a secret shared key. The cryptographic strength of HMAC depends on the properties of the underlying hash function. The IETF RFC-2101, entitled “HMAC: Keyed-Hashing for Message Authentication” is incorporated here by reference.

As is known in the art, an Electronic Code Book (ECB) is a mode of operation for a “block cipher,” with the characteristic that each possible block of plaintext has a defined corresponding cipher text value and vice versa. In other words, the same plaintext value will always result in the same cipher text value. Electronic Code Book is used when a volume of plaintext is separated into several blocks of data, each of which is then encrypted independently of other blocks. The Electronic Code Book has the ability to support a separate encryption key for each block type.

As is known in the art, Diffie and Hellman (DH) describe several differents group methods for two parties to agree upon a shared secret in such a way that the secret will be unavailable to eavesdroppers. This secret is then converted into various types of cryptographic keys. A large number of the variants of the DH method exist including ANSI X9.42. The IETF RFC-2631, entitled “Diffie-Hellman Key Agreement Method” is incorporated here by reference.

The network interface component 26 may also use Secure Socket Layer (SSL), Transport Layer Security (TLS) or Internet Protocol Security (IPsec). As is known in the art, the SSL protocol is a protocol layer which may be placed between a reliable connection-oriented network layer protocol (e.g. TCP/IP) and the application protocol layer (e.g. HyperText Transport Protocol (HTTP)). SSL provides for secure communication between a source and destination by allowing mutual authentication, the use of digital signatures for integrity, and encryption for privacy.

The SSL protocol is designed to support a range of choices for specific security methods used for cryptography, message digests, and digital signatures. The security method are negotiated between the source and destingation at the start of establishing a protocol session. The SSL 2.0 protocol specification, by Kipp E. B. Hickman, 1995 is incoroporated herein by reference. More information on SSL is available at the URL “netscape.com/eng/security/SSL2.html.”

As is known in the art, TLS provides communications privacy over the Internet. The protocol allows/server applications to communicate over a transport layer (e.g., TCP) in a way that is designed to prevent eavesdropping, tampering, or message forgery. For more information on TLS see IETF RFC-2246, incorporated herein by reference.

As is known in the art, IPsec is security protocol that provides authentication and encryption over the Internet. Unlike SSL, which provides services at OSI layer 4 and secures two applications, IPSec works at layer 3 (i.e., the OSI network layer) and secures networks including VPNs. The phone-based home gateway interface 18 also provides IPsec for secure communications (e.g., for VPNs). For more information on IPsec see IETF RFC-2401, the contents of which are incorporated by reference.

However, the present invention is not limited to the security or encryption techniques described and other security or encryption techniques can also be used to practice the invention.

An operating environment for devices and interfaces of the present invention include a processing system with one or more high speed Central Processing Unit(s) (“CPU”) or other types of processors and a memory. In accordance with the practices of persons skilled in the art of computer programming, the present invention is described below with reference to acts and symbolic representations of operations or instructions that are performed by the processing system, unless indicated otherwise. Such acts and operations or instructions are referred to as being “computer-executed,” “CPU executed” or “processor executed.”

It will be appreciated that acts and symbolically represented operations or instructions include the manipulation of electrical signals by the CPU. An electrical system represents data bits which cause a resulting transformation or reduction of the electrical signals, and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to the data bits.

The data bits may also be maintained on a computer readable medium including magnetic disks, optical disks, organic memory, and any other volatile (e.g., Random Access Memory (“RAM”)) or non-volatile (e.g., Read-Only Memory (“ROM”)) mass storage system readable by the CPU. The computer readable medium includes cooperating or interconnected computer readable medium, which exist exclusively on the processing system or be distributed among multiple interconnected processing systems that may be local or remote to the processing system.

As is known in the art, the Open Systems Interconnection (“OSI”) reference model is a layered architecture that standardizes levels of service and types of interaction for network devices exchanging information through a communications network. The OSI reference model separates network device-to-network device communications into seven protocol layers, or levels, each building and relying upon the standards contained in the levels below it. The OSI reference model includes from lowest-to-highest, a physical, data-link, network, transport, session, presentation and application layer. The lowest of the seven layers deals solely with hardware links; the highest deals with software interactions at the application-program level.

In one embodiment of the present invention, the wireless network interfaces 28 used for the electronic kiosk 12 include but are not limited to, an IEEE 802.11a, 802.11b, 802.11g, 802.11n, “Wireless Fidelity” (“Wi-Fi”), “Worldwide Interoperability for Microwave Access” (“WiMAX”), ETSI High Performance Radio Metropolitan Area Network (HIPERMAN), “RF Home” or other wireless interfaces.

As is known in the art, 802.11b defines a short-range wireless network interface. The IEEE 802.11b standard defines wireless interfaces that provide up to 11 Mbps wireless data transmission to and from wireless devices over short ranges. 802.11a is an extension of the 802.11b and can deliver speeds up to 54 Mbps. 802.11g deliver speeds on par with 802.11a. However, other 802.11xx interfaces can also be used and the present invention is not limited to the 802.11 protocols defined. The IEEE 802.11a, 802.11b and 802.11g standards are incorporated herein by reference.

As is known in the art, Wi-Fi is another type of 802.11xx interface, whether 802.11b, 802.11a, dual-band, etc. Wi-Fi devices include an RF interfaces such as 2.4 GHz for 802.11b or 802.11g and 5 GHz for 802.11a. More information on Wi-Fi can be found at the URL “www.weca.net.”

As is known in the art, WiMAX is an industry trade organization formed by communications component and equipment companies to promote and certify compatibility and interoperability of broadband wireless access equipment that conforms to the IEEE 802.16xx and ETSI HIPERMAN. HIPERMAN is the European standard for MANs.

The IEEE The 802.16a and 802.16g standards are wireless MAN technology standard that provides a wireless alternative to cable, DSL and T1/E1 for last mile broadband access. It is also used as complimentary technology to connect IEEE 802.11xx hot spots to the Internet.

The IEEE 802.16a standard for 2-11 GHz is a wireless MAN technology that provides broadband wireless connectivity to fixed, portable and nomadic devices. It provides up to 50-kilometers of service area range, allows users to get broadband connectivity without needing direct line of sight with the base station, and provides total data rates of up to 280 Mbps per base station, which is enough bandwidth to simultaneously support hundreds of businesses with T1/E1-type connectivity and thousands of homes with DSL-type connectivity with a single base station. The IEEE 802.16g provides up to 100 Mbps.

The IEEE 802.16e standard is an extension to the approved IEEE 802.16/16a/16g standard. The purpose of 802.16e is to add limited mobility to the current standard which is designed for fixed operation.

The ESTI HIPERMAN standard is an interoperable broadband fixed wireless access standard for systems operating at radio frequencies between 2 GHz and 11 GHz.

The IEEE 802.16a, 802.16e and 802.16g standards are incorporated herein by reference. More information on WiMAX can be found at the URL “www.wimaxforum.org.” WiMAX can be used to provide a wireless local loop (WLP).

The ETSI HIPERMAN standards TR 101 031, TR 101 475, TR 101 493-1 through TR 101 493-3, TR 101 761-1 through TR 101 761-4, TR 101 762, TR 101 763-1 through TR 101 763-3 and TR 101 957 are incorporated herein by reference. More information on ETSI standards can be found at the URL “www.etsi.org.”

Coupon Sweepstakes Object

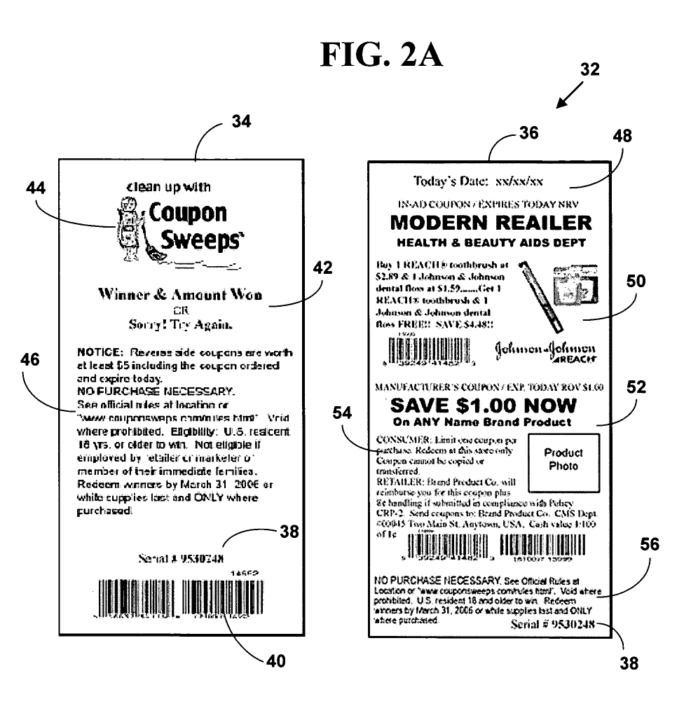

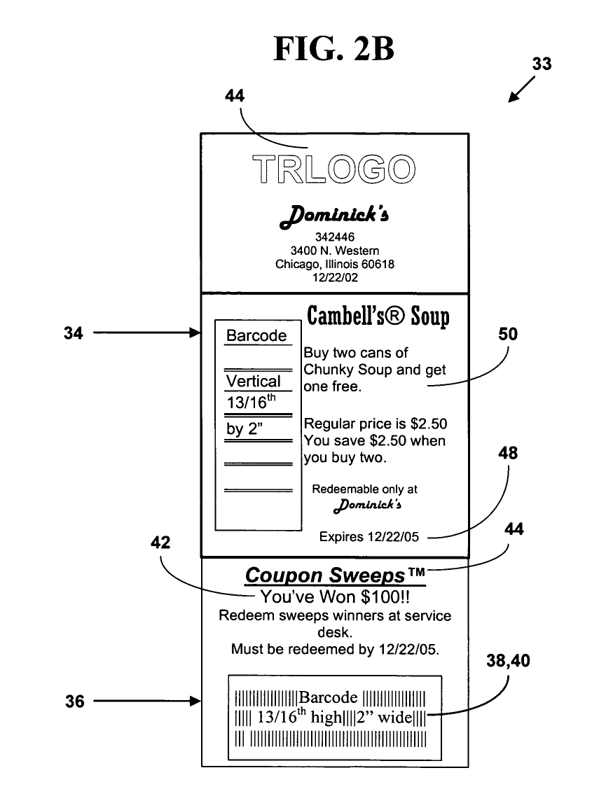

FIG. 2A is a block diagram illustrating an exemplary coupon sweepstakes object 32 dispensed from the coupon and sweepstakes dispensing system 10 of FIG. 1.

FIG. 2B is a block diagram illustrating another exemplary coupon sweepstakes object 33 dispensed from the coupon sweepstakes dispensing system 10 of FIG. 1.

In one embodiment the coupon sweepstakes object 32 includes a double-sided coupon sweepstakes objects with a sweepstakes portion 34 including sweepstakes information on a first side and a coupon portion 36 including coupon information on a second side as is illustrated in FIG. 2A.

In another embodiment, the coupon sweepstakes object includes a single-sided coupon sweepstakes object 33 including a sweepstakes portion 34 and a coupon portion 36 combined onto one same side of a printed paper as illustrated in FIG. 2B.

The sweepstakes portion 34 includes sweepstakes information including, but not limited to, a sweepstakes serial number 38, a sweepstakes security identifier 40, a winner identifier with an amount won 42 or loser identifier 42, a sweepstakes identifier 44, optional sweepstakes rules or information 46, and other types of sweepstakes information.

The sweepstakes security identifier 40 includes, but is not limited to, a sweepstakes production number and UPC code or RFID showing production number and expiration date, etc. In one embodiment, the sweepstakes serial number 38 is a separate number (FIG. 2A). In another embodiment, the sweepstakes serial number 38 is encoded in the sweepstakes security identifier 40 (FIG. 2B).

The winner or loser identifier 42, includes, but is not limited to, a winner notification and winning amount or “Sorry! Try Again” text, or other such equivalent loser notification, etc.

The sweepstakes identifier 44, includes, but is not limited to, a sweepstakes name, graphical artworks identifying the sweepstakes, etc.

The optional sweepstakes rules or information 46 includes, but is not limited to, “No Purchase Necessary” and promotion termination date or while supplies last, where to find complete rules, web-site, etc., notice that “reverse side coupons are worth at least five times your purchase price when redeemed”. “Must be 18 yrs. or older to win and not eligible if employed by retailer or marketer or member of their immediate family,” etc.

The coupon portion 36 includes coupon information for one or more products or services including, but not limited to, date and/or time information 48, plural coupons including a first coupon 50 and a second coupon 52, etc., including coupon information 54 comprising, a redemption value (e.g., $1.00), a manufacturer identifier, etc.

In another embodiment the coupon portion also includes related sweepstakes information including, but not limited to additional or identical sweepstakes information 56 and the sweepstakes serial number 38 printed on the sweepstakes portion 34. The sweepstakes serial number 38 ties the one or more coupons on the coupon portion 36 to the sweepstakes on the sweepstakes portion 34.

The coupon information 54 includes, but is not limited to, identify location where purchased (e.g., “Redeem Here ONLY”, etc.), department identity, coupon ordered and other available offers totaling X times the purchase price, expiration date in bold letters, abbreviated “No Purchase Necessary” rules, bar code or RFID to be used at Point-of-Sale (POS) checkout, logo of store/chain, In-Ad Coupon (e.g., printed in bold type located at top center of the coupon), agreed upon redemption value (ROV)) (e.g., top right corner) and/or max redemption value (MROV) and retail price, or no redemption value (NRV), in-store sponsored coupon, manufacturer name (e.g., lower left corner) and address or redemption center name and address, state specific information (e.g., IN, UT, and WA declaration of cash redemption value, etc.), manufacturer provided artwork must be programmed into an acceptable format to be reproduced.

In other embodiments, selected ones of the coupon items (48-56) are printed on the coupon portion 36 and selected ones of the sweepstakes items (40-46) are printed on the sweepstakes portion 34.

In one embodiment of the invention, a size for redemption purposes includes a size of 2.5 inches by 6 inches minimum, with a preferred size of 3 inches by 6 inches. However, the present invention is not limited to such an embodiment, and other sizes can also be used for the coupon sweepstakes object 32, 33.

In one embodiment, the coupon sweepstakes object 32, 33 is printed on security paper to prevent fraud by a printer in printing component 22 and dispensed to a customer via dispensing component 24 on the electronic kiosk 12. In one embodiment, the coupon sweepstakes object 32, 33 is printed with magnetic or other security inks used to print checks or other financial instruments. In another embodiment, the coupon sweepstakes object 32, 33 includes micro-coded information similar or identical to that used on check or other financial instruments.

In one embodiment, the coupon sweepstakes object 32, 33 includes plural selected coupons that include a redemption value N-times greater than a purchase price for the plural selected coupons and a free sweepstakes entry with a potential winning redemption value M-times greater than the purchase price of the plurality of selected coupons, where M is greater than N. For example, if the purchase for the selected coupons was $1, the redemption value might be at least N-times, where N is equal to five or more times the purchase price. The potential winning redemption value is one-hundred or more time the purchase price or for a purchase price of $1, the free sweepstake winner might be equal to $100.

In one embodiment, the coupon sweepstakes object 32, 33 includes coupons and sweepstakes entries that are redeemable only at the store they were purchased or printed at. In another embodiment, the coupons sweepstakes object 32 includes coupons and/or sweepstakes entries that are redeemable at other stores. For example, retail chain-A may partner with retail chain-B and coupons for retail chain-B may be printed by electronic kiosks in retail chain-A stores but redeemed in retail chain-B stores.

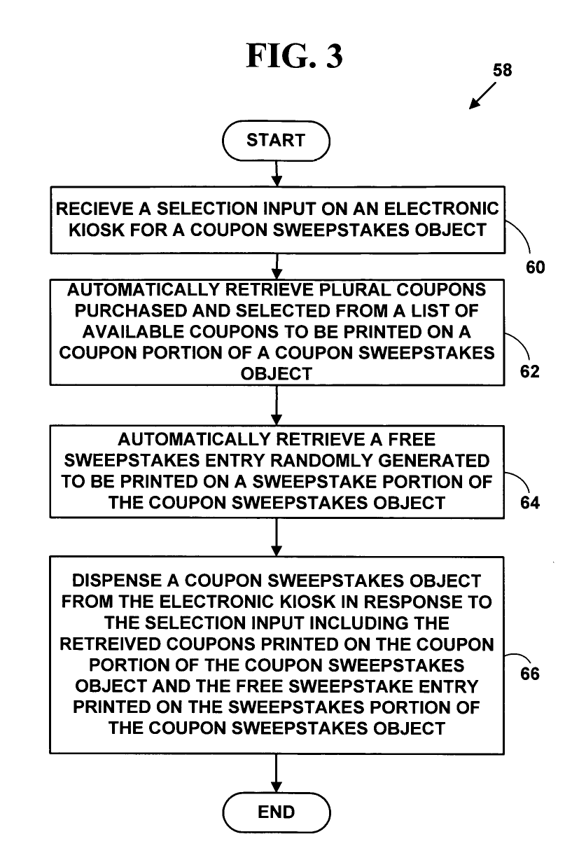

FIG. 3 is a flow diagram illustrating a Method 58 for providing a coupon sweepstakes object 32, 33. At Step 60, a selection input is received on an electronic kiosk 12 for a coupon sweepstakes object 32, 33. At Step 62, plural coupons are automatically retrieved from a list of available coupons to be printed on a coupon portion 36 of a coupon sweepstakes object 32, 33. At Step 64, a free sweepstakes entry is automatically retrieved to be printed on a sweepstake portion 34 of the coupon sweepstakes object 32, 33. At Step 66, a coupon sweepstakes object 32, 33 is dispensed from the electronic kiosk 12 in response to the selection input including the plural selected coupons on the coupon portion 36 of the coupon sweepstakes object 32, 33 and the free sweepstake entry on the sweepstakes portion 34 of the coupon sweepstakes object 32, 33.

Method 58 is illustrated with an exemplary embodiment. However, the present invention is not limited to such an exemplary embodiment and other embodiments can also be used to practice the invention.

In such an exemplary embodiment at Step 60, a selection input is received on an electronic kiosk 12 for a coupon sweepstakes object 32, 33 from a customer. The customer would have made the selection input from using the touch screen component 16 or via the card reader component 18 (e.g., by swiping or inserting a customer card, loyalty card, etc.) or via the virtual electronic kiosk 12 described above.

In one embodiment, the selection input is received and includes receiving an electronic payment via the card reader component 18 or a cash payment via the currency input component 20. In exchange for an electronic payment or cash payment of $nn.nn, the electronic kiosk 12 will dispense one or more coupon sweepstakes objects 32 with a coupon value of at least X*$nn.nn, where X is a variable number (e.g., 2 or more) determined by the electronic kiosk 12. For example, if a customer input an electronic payment of $1.00, the electronic kiosk 12 would dispense coupons redeemable for at least $5.00. In addition, the customer automatically receives a free sweepstakes entry that enters the customer in a sweepstakes with a potential to win additional prizes (e.g., a cart of groceries, retail goods, etc.), cash prizes, store credit, etc.

At Step 62, plural selected and purchased coupons are automatically retrieved from a list of available coupons to be printed on a coupon portion 36 of a coupon sweepstakes object 32, 33.

In one embodiment, the plural coupons are securely (e.g., encryption, SSL, TLS, etc.) and automatically retrieved from an external server 30 via the communications network 28. In another embodiment, the plural coupons are retrieved from local memory, a local database or other local computer readable medium in the electronic kiosk.

In one embodiment, the one or more coupons are automatically retrieved from a list of available coupons redeemable on a day the selection input was received.

In another embodiment, the one or more coupons are automatically retrieved based on information input by a customer via the touch screen component 16, based on the customer's current preferences for coupons redeemable for sale items.

In another embodiment of the invention, the one or more coupons are selected based on information included on a customer card entered via the card reader component. For example, a customer may have pre-selected a list of coupons (e.g., via a web-site on communications network 28) and the coupon information was written directly onto the customer card and retrieved via the card reader component 18.

In another embodiment of the invention, the one or more coupons are automatically retrieved based on information obtained from a customer profile generated for a customer using customer input from the touch screen component 16 or via the card reader component 18 or via the virtual kiosk 12. In one embodiment the customer profile may include previous purchases made by the customer and generated by the electronic kiosk 12 or obtained from a server 30 via the communications network 28. In another embodiment, the customer profile may be generated by the customer him/herself (e.g., via a web-site on a communications network 28).

At Step 64, a sweepstakes entry is automatically retrieved by the electronic kiosk 12 and made available on a sweepstake portion 34 of the coupon sweepstakes object 32, 33. In one embodiment, the plural coupons are securely (e.g., encryption, SSL, TLS, etc.) and automatically retrieved from an external server 30 via the communications network 28.

In another embodiment, the plural coupons are retrieved from local memory, a local database or other local computer readable medium in the electronic kiosk. In such an embodiment of the invention, the electronic kiosk 12 automatically electronically randomly and securely generates a sweepstakes entry via its CPU, memory and pre-programmed instructions that are printed on the sweepstakes portion 34 of the coupon sweepstakes object 32, 33 by a printer in the printer component 22.

In another embodiment, the electronic kiosk 12 automatically and randomly generates a sweepstakes entry via selecting a pre-printed coupon sweepstakes object 32, 33 from plural coupon sweepstakes objects 32, 33 (e.g., on a roll of pre-printed objects) available in the printing component 22. In such an embodiment, the printing component 22 randomly selects with mechanical movements a coupon sweepstakes object 32, 33 with a pre-printed sweepstakes entry. In such an embodiment, each roll of pre-printed objects would comprise one sweepstakes offering with a pre-determined number of winners (e.g., one winner of a cartful of groceries, etc.) When such a pre-printed roll is exhausted, that sweepstakes would end, and other roll would be selected to start a new sweepstakes (e.g., store credit including, one $100 winner, two $50 winners, four $25 dollar winners, etc.).

At Step 66, a coupon sweepstakes object 32, 33 is dispensed from the electronic kiosk 12 in response to the selection input including the retrieved plural coupons on printed on the coupon portion 36 of the coupon sweepstakes object 32, 33 and the retrieved sweepstake entry printed on the sweepstakes portion 34 of the coupon sweepstakes object 32, 33.

In one embodiment, the entire coupon sweepstakes object 32, 33 is printed by a printer in the printer component 22 in the electronic kiosk 12 and dispensed via the dispensing component 24. In another embodiment, a pre-printed sweepstake portion 34 is selected and the one or more selected coupons are printed on the coupon portion 36 by the printer in the printer component 22.

Providing Coupon Sweepstakes Objects

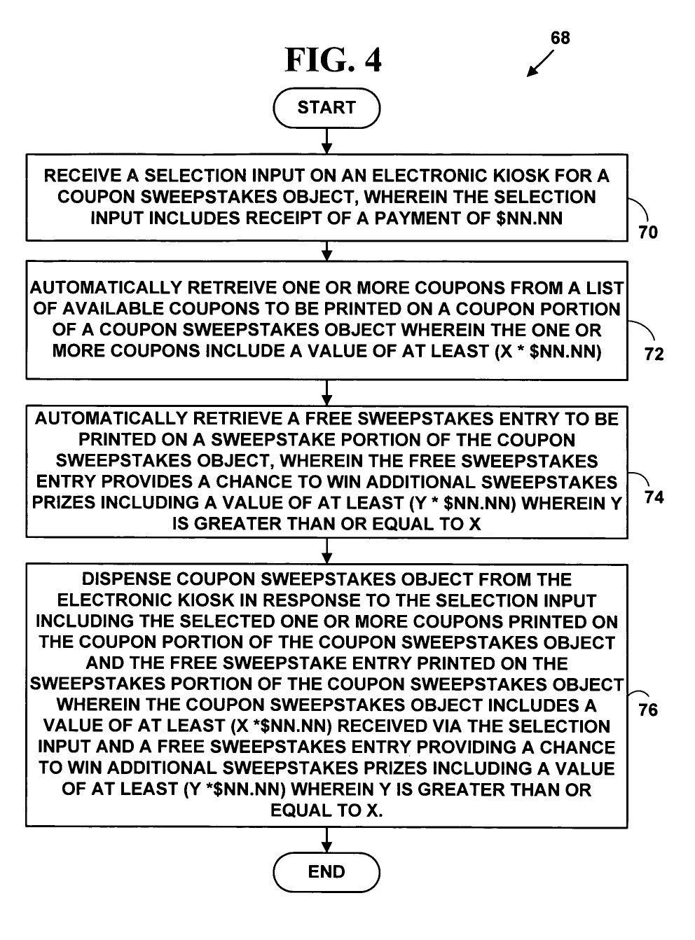

FIG. 4 is a flow diagram illustrating a Method 68 for providing a coupon sweepstakes object 32, 33. At Step 70, a selection input is received on an electronic kiosk 12 for a coupon sweepstakes object 32, 33, wherein the selection input includes receipt of a payment of $nn.nn. At Step 72, one or more coupons are automatically retrived from a list of available coupons to be printed on a coupon portion 36 of a coupon sweepstakes object 32, 33, wherein the one or more coupons include a value of at least (X*$nn.nn) and wherein X is selected from the set of (2, 3, 4, . . . ). At Step 74, a free sweepstakes entry is randomly generated to be printed on a sweepstake portion 34 of the coupon sweepstakes object 32, 33, wherein the free sweepstakes entry provides a chance to win additional sweepstakes prizes including a value of at least (Y*$nn.nn) wherein Y is greater than or equal to X. At Step 76, a coupon sweepstakes object 32, 33 is dispensed from the electronic kiosk 12 in response to the selection input including the selected one or more coupons printed on the coupon portion 36 of the coupon sweepstakes object 32, 33 and the free sweepstake entry printed on the sweepstakes portion 34 of the coupon sweepstakes object 32, 33, wherein the coupon sweepstakes object 32, 33 includes a value of at least (X*$nn.nn) received via the selection input and the free sweepstakes entry providing a chance to win additional sweepstakes prizes including a value of at least (Y*$nn.nn) wherein Y is greater than or equal to X.

Method 68 is illustrated with an exemplary embodiment. However, the present invention is not limited to such an exemplary embodiment and other embodiments can also be used to practice the invention.

In such an exemplary embodiment at Step 70, a selection input is received on an electronic kiosk 12 for a coupon sweepstakes object 32, 33, wherein the selection input includes receipt of a payment of $nn.nn.

In one embodiment, the selection input is received and includes receiving an electronic payment via the card reader component 18 or a cash payment via the currency input component 20.

At Step 72, one or more coupons are automatically retrieved from a list of available coupons to be printed on a coupon portion 36 of a coupon sweepstakes object 32, 33, wherein the one or more coupons include a value of at least (X*$nn.nn) and wherein X is selected from the set of (2, 3, 4, . . . ).

In exchange for an electronic payment or cash payment of $nn.nn, the electronic kiosk 12 will dispense one or more coupon sweepstakes objects 32 with a coupon value of at least X*$nn.nn, where X is a variable number (e.g., 2 or more) determined by the electronic kiosk 12. For example, if a customer input an electronic payment of $1.00, the electronic kiosk 12 would dispense coupons redeemable for at least $5.00 (e.g., X=5).

In one embodiment, the one or more coupons are retrieved from a list of available coupons redeemable only on a day the selection input was received. In another embodiment, the coupons are redeemable on days other than the day the selection input was received.

In another embodiment, the one or more coupons are retrieved based on information input by a customer via the touch screen component 14, based on the customer's current preferences for coupons redeemable for sale items.

In another embodiment of the invention, the one or more coupons are retrieved based on information included on a customer card entered via the card reader component. For example, a customer may have pre-selected a list of coupons (e.g., via a web-site on communications network 28) and the coupon information was written directly onto the customer card and retrieved via the card reader component 18.

In another embodiment of the invention, the one or more coupons are retrieved based on information obtained from a customer profile generated for a customer using customer input from the touch screen component 16 or via the card reader component 18. In one embodiment the customer profile may include previous purchases made by the customer and generated by the electronic kiosk 12 or obtained from a server 30 via the communications network 28. In another embodiment, the customer profile may be generated by the customer him/herself (e.g., via a web-site on a communications network 28).

At Step 74, a free sweepstakes entry is automatically retrieved by the electronic kiosk 12 and made printed on a sweepstake portion 34 of the coupon sweepstakes object 32, 33.

In one embodiment, a sweepstakes entry is automatically retrieved by the electronic kiosk 12 and made available on a sweepstake portion 34 of the coupon sweepstakes object 32, 33. In one embodiment, the plural coupons are securely (e.g., encryption, SSL, TLS, etc.) and automatically retrieved from an external server 30 via the communications network 28.

In another embodiment, the electronic kiosk 12 electronically automatically randomly generates a sweepstakes entry via its CPU, memory and pre-programmed instructions that is printed on the sweepstakes portion 34 of the coupon sweepstakes object 32, 33 by a printer in the printer component 22.

In another embodiment, the electronic kiosk 12 randomly generates a free sweepstakes entry via selecting a pre-printed coupon sweepstakes object 32, 33 from plural coupon sweepstakes objects 32 (e.g., on a roll of pre-printed objects) available in the printing component 22. In such an embodiment, the printing component 22 randomly selects with mechanical movements a coupon sweepstakes object 32, 33 with a pre-printed sweepstakes entry. In such an embodiment, each roll of pre-printed objects would comprise one sweepstakes offering with a pre-determined number of winners (e.g., one winner of a cartful of groceries, etc.) When such a pre-printed roll is exhausted, that sweepstakes would end, and other roll would be selected to start a new sweepstakes (e.g., store credit including, one $100 winner, two $50 winners, four $25 dollar winners, etc.).

At Step 76, a coupon sweepstakes object 32, 33 is dispensed from the electronic kiosk 12 in response to the selection input including the selected one or more coupons printed on the coupon portion 36 of the coupon sweepstakes object 32, 33 and the free sweepstake entry printed on the sweepstakes portion 34 of the coupon sweepstakes object 32, 33, wherein the coupon sweepstakes object 32, 33 includes a value of at least (X*$nn.nn) received via the selection input and the free sweepstakes entry providing a chance to win additional sweepstakes prizes including a value of at least (Y*$nn.nn) wherein Y is greater than or equal to X.

For example, if an electronic or cash payment of $1.00 was received from a customer on the electronic kiosk 12, the electronic kiosk 12 would dispense coupons redeemable for at least $7.00 (i.e., $1.00*7=$7.00 of coupon value). In addition, the customer automatically receives a free sweepstakes entry that enters the customer in a sweepstakes with a potential to win additional prizes (e.g., a cart of groceries, retail goods, etc.), cash prizes, store credit, etc. (e.g. $1.00*50=$50.00 of sweepstakes value, where Y=50 and X=7).

In one embodiment, the entire coupon sweepstakes object 32, 33 is printed by a printer in the printer component 22 in the electronic kiosk 12 and dispensed via the dispensing component 24. In another embodiment, a pre-printed sweepstakes portion 34 is selected and the one or more selected coupons are printed on the coupon portion 36 by the printer in the printer component 22.

The coupon sweepstakes object 32, 33 and the electronic kiosk 12 can also be used for a method cooperative promotional advertising.

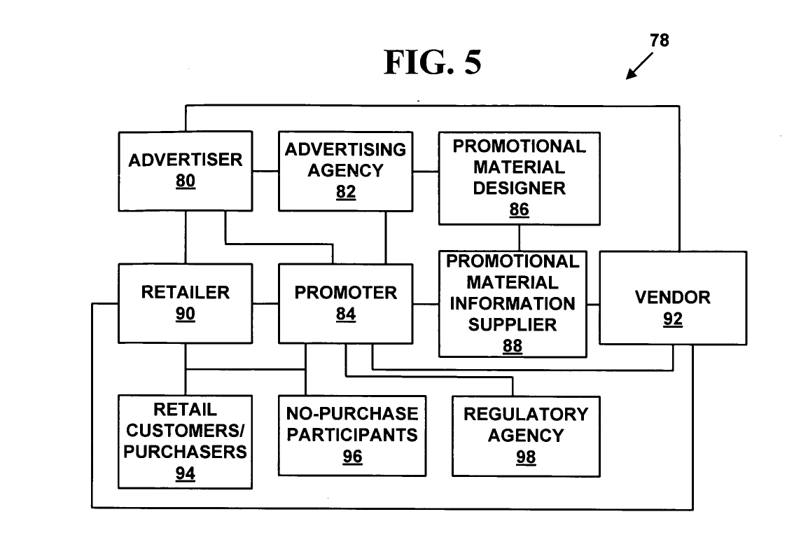

FIG. 5 is a block diagram 78 of a set of main participants for the cooperative promotional advertising method.

A first advertiser 80 can be any entity with a product, i.e. goods and/or services, to sell. The advertiser 80 can involve an advertising agency 82, which could engage a promoter 84. Alternatively, the advertiser 80 can deal directly with the promoter 84 or complete their own advertising campaign. The first advertiser 80 and the promoter 84 are illustrated as different entities. However, the first advertiser 80 and the promoter 84 can also be the same entity. The coupon sweepstakes objects 32 graphics can be designed by a promotional material designer 86 for production by a promotional material information supplier 88.

In addition to arranging for the design of the coupon sweepstakes object 32, 33, the promoter 84 arranges for their distribution to retail entities 90 via the electronic kiosks 12. Since the retail entities 90 sell the coupon sweepstakes objects 32 in order to generate revenue and also to increase traffic in their establishments, the retailers 90 comprise a second or additional advertiser or second promoter whereby a synergistic, co-promotion of goods and services of the primary advertiser 80 and the retailer 90 is achieved. The coupon sweepstakes object 32, 33 can also be provided to the retailer 90 by a vendor 92, such as a distributor.

Customers 94 of the retailer 90 comprise the purchasers of the coupon sweepstakes objects 32. Thus, the retailers 90 can be carefully chosen based on their customer profiles and demographics. For example, the goods and/or services of the advertiser 80 can be matched with retailers 90 whose customers 94 would be most likely to purchase the advertised goods and/or services from the coupon sweepstakes objects 32. The advertised goods and/or services can correspond to the goods and/or services of the retailer 90 whereby significantly greater redemption of the coupon sweepstakes objects 32 can also occur from a targeted group of potential customers 94. Moreover, retailers 90 with multiple retail store locations can carry specific coupon sweepstakes objects 32, and can distribute the specific coupon sweepstakes objects according to the demographics of their various locations.

The serial numbers 38 and the sweepstakes security identifier 40 on the coupon sweepstakes object 32, 33 provide a means for tracking the sales of the coupon sweepstakes objects 32. For example, the advertiser 80 or the promoter 84 can monitor the volume of redeemed coupon sweepstakes objects 32 and using the serial numbers 38 or sweepstakes security identifiers 40 printed thereon, can determine which retailers 90 received the corresponding coupon sweepstakes objects 32 from which the redeemed coupon sweepstakes objects 32 were sold via the electronic kiosks 12. Such information can be utilized to quantitatively monitor the success of the entire advertising campaign. Valuable market research can be generated thereby.

In addition to the regular retail customers 94 who purchase the coupon sweepstakes objects 32, if the coupon sweepstakes objects 32 include a game of chance, gaming laws and regulations in some areas require that the coupon sweepstakes objects 32 also be available to participants 96 who do not make purchases. Such no-purchase participants 96 can be accommodated by the advertiser 80 or promoter 84, who can receive their “entries” in the promotion and make awards as appropriate. The advertiser 80 or promoter 84 can also handle regulatory agency 98 approvals, permits, licenses, etc.

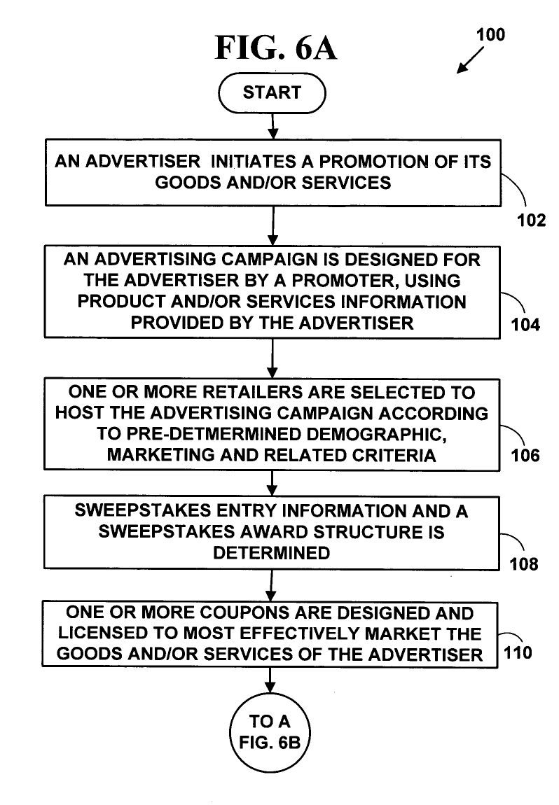

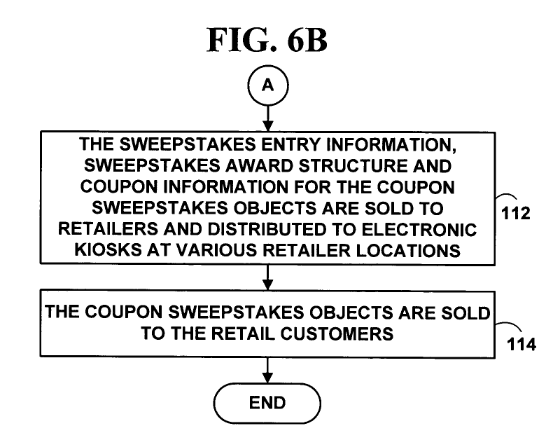

FIGS. 6A and 6B are a flow diagram illustrating a Method 100 for co-promotional advertising using coupon sweepstakes objects 32. In FIG. 6A at Step 102, an advertiser 80 initiates a promotion of its goods and/or services. At Step 104, an advertising campaign is designed for the advertiser 80 using product and/or services information provided by the advertiser 80. In one embodiment, the promoter 84 designs the advertising campaign for the advertiser 80. In another embodiment, the advertiser 80 designs its own promotion, without the assistance of a promoter 84. At Step 106, one or more retailers 90 are selected to host the advertising campaign for the advertiser 80 according to pre-determined demographic, marketing and related criteria. At Step 108, sweepstakes entry information and a sweepstakes award structure is determined. At Step 110, one or more coupons are designed and licensed to most effectively market the goods and/or services of the advertiser 80 and to create the broadest possible appeal to the customers 94 of the retailers 90.

In FIG. 6B at Step 112, the sweepstakes entry information, sweepstakes award structure and coupon information for the coupon sweepstakes objects 32 are sold to retailers 90 and distributed to electronic kiosks 12 at various retailer 90 locations. At Step 114, the coupon sweepstakes objects 32 are sold to the retail customers 94 (e.g., using Methods 58 and 68). In one embodiment, a new sweepstakes is started within a pre-determined number of days (e.g., every 90 days).

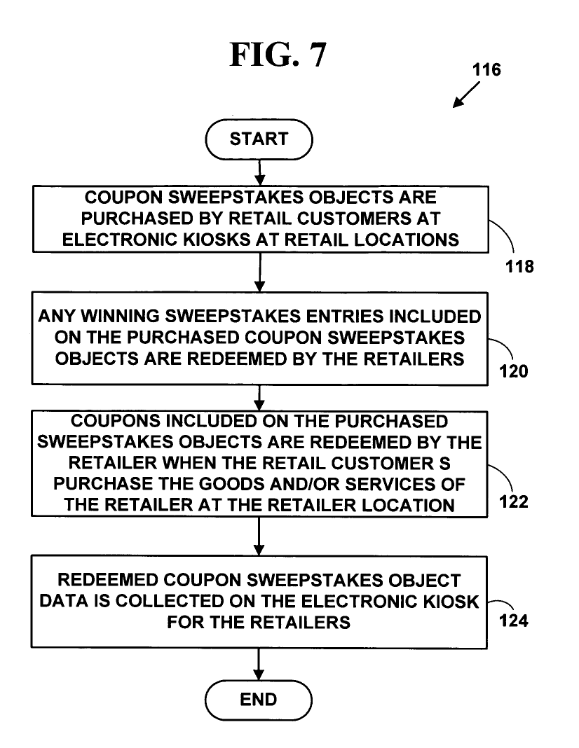

FIG. 7 is a flow diagram illustrating a Method 116 for co-promotional advertising using coupon sweepstakes objects 32. At Step 118, coupon sweepstakes objects 32 are purchased by retail customers 94 at electronic kiosks 12 at retailer 90 locations. Since the coupon sweepstakes objects 32 have a value in excess of its purchase price and have an expiration date of the date of purchase, the customers 94 are enticed to immediately purchase the goods and/or services promoted thereon from the advertiser 80 identified thereon and also potentially make impulse purchases. Moreover, a significant entertainment component is provided in the course of playing the free sweepstake including on the coupon sweepstakes objects 32 since the element of chance and immediate reward adds considerably to the interest and motivation of the retail customers 94. At Step 120, any winning sweepstakes entries included on the purchased coupon sweepstakes objects 32 are redeemed by the retailers 90. At Step 122, coupons included on the purchased sweepstakes objects 32 are redeemed by the retailers 90 when the retail customer 94 purchase the goods and/or services at the retailer 90 location. At Step 124, redeemed coupon object 32 data is collected on the electronic kiosk 12. The advertiser 80 can take advantage of the sales data by tracking serial numbers 38 and/or sweepstakes security identifiers 40 of coupon sweepstakes objects 32 redeemed by the retail customers and thereby determine which retail establishments 90 are most effective for the purposes of the promotion. For example, geographic locations, types of retail establishments and other factors can be taken into account whereby the advertiser 80 can maximize its revenue from conducting such promotions including where to place additional electronic kiosks 12. Sweepstakes award redemption data can also be tracked to judge the effectiveness of various types of sweepstakes and corresponding awards.

The methods and systems described herein allows merger of two tried and true marketing methods, coupons and sweepstakes. The coupon sweepstakes objects 32 are distributed by front door retailer 90 access electronic kiosks 12 that places the retail customer 94, retailer 90 and the advertiser 80 and/or promoter 84 in a win-win-win situation. The methods and system described herein help retailers and advertisers reach consumers with their product offers. Retail shoppers 94 select their coupons with one of the methods described above, pay a nominal fee for the time saved, convenience, value and variety, plus automatically, are entered into a free sweepstakes that can bring cash or credit at the retail establishment where they are shopping. The electronic kiosk 12 can also be used to provide advertising revenue (e.g., on the coupon sweepstakes object 32, 33, the customer attraction component 14 or the touch screen component 16).

Using retailer 90 front door access and electronic kiosk 12 technology and the methods described herein, additional retail income streams are generated from the consumers demanding the convenience of instantly picking out the coupons they will be using the day and time they visit the retailer having in hand a list of consumer product categories they are there to shop for.

For example, at the top of the list may be cereal. The retail customer 94 will be able to select a cereal icon on the touch screen component 16 and buy a cereal coupon worth at least five times the purchase price and redeemable in the immediate facility, along with a map showing where the cereal is in the store). This retail consumer 94 demand for convenience, instant gratification and habitual use of coupons, drives this market. Add to this, at no extra charge, the chance to win cash or a couple weeks worth of products sold by the retailer 90 and you have what some retailers 90 have called an additional retail customer 94 attractive not only save with, but have fun while saving.

Since the retailer 90 sells the coupon sweepstakes objects 32 (because of it's value and convenience), they are introduced to a new, intangible product (e.g., retail tax free) and heretofore non-existing income stream. Selling coupon sweepstakes objects 32 retailers will not only be able to pay off the winners, and is estimated could earn retailers 90 tangible profits as a result of its use and increase sales through about up to a 26% redemption rate. The electronic kiosk 12 requires no attendant and can also introduce the customers to in-store promotions that they would not have otherwise been aware of.

In one embodiment, the electronic kiosk 12 include plural software modules comprising: (1) a kiosk module; (2) an attraction loop module; (3) a transaction processing module; (4) coupon selection module; (5) sweepstakes entry module; (6) sweepstakes entry verification module; and (7) configuration and monitoring module. However, the present invention is not limited to these modules and more, fewer and other modules can be used to practice the invention.

In another embodiment, the electronic kiosk 12 further includes plural software modules comprising: (1) a coupon generation module; (2) sweepstakes generation module; (3) kiosk management module; and (4) reports module.

In another embodiment, the remote server 30 includes plural software modules comprising: (1) a coupon generation module; (2) sweepstakes generation module; (3) kiosk management module; and (4) reports module.

Kiosk module: A kiosk module includes all software that runs entirely on the electronic kiosk 12. The electronic kiosk components communicate with the other modules via an Application Programming Interface (API) message format. Parameters passed between the various modules include error checking.

Attraction loop module: Attraction loops are provided for the customer attraction component 14 are for three environments: supermarket storefront, inside convenience store, and at-pump convenience store. The opening animation and graphic layout are eye catching. Readability and visual stimulation is used in environments where bright sunlight may obscure displays and loud diesel or car engines may drown out any audio. Graphics are bright and bold and audio volume adjustable to high for noisy locations. In all locations, an enticing animation will is used in convincing busy shoppers to take time form their day to use the electronic kiosk 12 by catching their eye and presenting them with a compelling value proposition.

Transaction processing module: Customers insert currency or credit, debit, gift, retail, loyalty, etc. card via the card reader component 18 prior to proceeding to coupon selection. Payment is verified before allowing customer to proceed to coupon selection. Payment made via credit card are verified via a credit card module. Payments made via currency component 20 are verified via return codes from the device. An in-store credit receipt will be issued when there is a cash credit required upon transaction completion (e.g., buying $3 worth of coupons with a $5 bill).

Coupon Selection Module: Once payment has been verified, the customer may browse departments to select the primary coupon for purchase. As coupons are selected, the customer will see displayed on the screen the coupons selected and their total savings. They may continue selecting coupons or choose to print. When the customer has completed selecting coupons and has chosen to print, related coupons will be automatically chosen to bring their purchase to the minimum X*purchase price (e.g., 5 times purchase price). Customers browse virtual “aisles” and “shelves” using a virtual layout or map or a supermarket or convenience store.

Sweepstakes Entry Module: One sweepstakes entry will be generated for each set of coupons (purchased coupon plus compiled selection). When the coupon selection has been completed and the customer has finalized the transaction, the kiosk module sends a message to the sweepstakes entry module to request a free sweepstake entry in a currently running sweepstakes. In one embodiment, the sweepstakes entry module securely retrieves the free sweepstakes entry from an external server 30 via the communications network 28 to the kiosk to be printed on the coupon sweepstakes object 32, 33. In another embodiment, the sweepstakes entry module securely retrieves the free sweepstakes entry from an internal computer readable medium on the electronic kiosk 12.

Sweepstakes Entry Verification Module (C-Store only): Free Sweepstakes entries printed on Coupon Sweepstakes Objects 32 at-pump in convenience stores will show the sweepstakes entry number, but will not indicate whether or not it is a winner. The customer will have to go into the store and swipe their sweepstakes ticket under the bar code reader in the in-store kiosk 12. The status of the ticket, winner or loser, will display on the screen. If the ticket is a winner, the in-store kiosk will print a redeemable winning ticket displaying the value.

Configuration and Monitoring Module: The kiosk module maintains a hardware and software configuration file that will detail components, version numbers, mac address, configuration type, kiosk ID, etc. The kiosk module has the ability to respond to ping requests from the kiosk monitoring module by checking the status of its components and sending detailed or summary status reports. The kiosk module is able to detect status conditions from its hardware components and take appropriate action to notify the monitoring module, the field support team or store manager as required. For problems that make the kiosk unable to complete transactions, e.g. paper out, display on-screen message to notify store manager.

When the electronic kiosk 12 boots, the kiosk module check its components and sends a message to the monitoring module with a date/time stamp and component status. The electronic kiosk and the remote server 30 complete a security handshaking process before the kiosk is enabled on the network. This security handshaking lowers the risk for hackers to attempt to connect to the system by emulating a valid electronic kiosk 12. Monitoring of the temperature of the electronic kiosk 12 will be performed to collect data for possible problem prediction and electronic kiosk 12 overheating.

In one embodiment, the remote server 30 includes plural software modules comprising: (1) a coupon generation module; (2) sweepstakes generation module; (3) kiosk management module; and (4) reports module. However, the present invention is not limited to these modules and more, fewer and other modules can be used to practice the invention.

Coupon generation module: Manufacturers and store managers (as Coupon Admins) require a method of entering coupon data into a database and assigning them to store departments. The system includes a billing function to allow the electronic kiosk 12 to charge manufacturers for coupon placement.

UPC Coupon Codes: The coupon database supports UCC coupon encoding standards. Coupon data input by Coupon Admins will checked for validity and properly barcoded to ensure proper scanning and redemption during checkout at the point-of-sale.

In one embodiment, a direct cross-reference between UPC product codes and UPC coupon codes used. In another embodiment, a direct cross-reference between UPC product codes and UPC coupon codes is not used. In another embodiment other types of UPC codes can also be used.

Basic Coupon Format: The UPC coupon code is an all numeric code that comprising of the following format illustrated in Equation 1. However, the present invention is not limited to the format illustrated in Equation 1 and other UPC coupon codes can be used to practice the invention.
5 12345 87890 4, (1)
wherein, the first digit, 5, is the UCC prefix that indicates the code is a coupon. The next set of digits 12345 identify the company (this is actually digits 2-6 of the company prefix. Companies with access to the Coupon Sweeps/Coupon Road database will have accounts that identify them by company prefix number and limit them to creating coupons with their company prefix. The next three digits, 878, represent the family code. The next three digits, 90, are the value code. The final digit, 4, is a checksum digit. They represent the redemption value of the coupon. In-store coupons replace the leading 5 with “99” to indicate that it is an in-store coupon. The remaining information is the same as a regular coupon. For more information on UPC codes, see URL “www.barcode-us.com.”

UCC/EAN-128 Coupon Extended Code format: The format for UCC/EAN-128 coupon extended code Type 2 is as illustrated in Equation (2). However, the present invention is not limited to the format illustrated in Equation 2 and other coupon codes can be used to practice the invention.
(8101)0 67890 0799, (2)
wherein (8101) is an application identifier; the zero is the first digit of a company code; the next five digits, 67890 are an offer code; and the last 4 digits are an expiration date.

Coupon Admin Interface: Coupon information may be entered into the coupon generation module by grocery store or convenience store personnel, product manufacturers, and store/chain managers. Product manufacturers are identified by their UPC company code and are restricted to creating coupons with their company code. Store/chain managers are able to create store coupons, and are also be able to create company coupons for store brands that can be identified by a valid UPC company code. grocery store or convenience store personnel have the ability to enter any manufacturer or store coupon on the approval of the coupon issuer. This interface includes a billing and reporting system included on the back end of the Coupon Admin Interface. Manufacturers are charged to place their coupons in the system.

Coupon Data Entry: Coupon data entry mode allows a coupon admin to manually input coupon information via a privileged account via the communications network 28. Through this interface, the coupon admin is able to add, modify and delete coupon offers. The interface does data checking to ensure proper company prefixes, value codes and checksum digits. The coupon entry process acts as a kind of content management system that displays the entered coupon data as it would appear on the coupon.

Coupon Data Upload: The coupon admin interface allows upload/import of coupon data from simple, pre-defined format files. The same data checking performed for coupon data entry will applies to coupon data upload. Error conditions are displayed to the coupon admin.

Coupon Department Assignment: Once a coupon data has been entered in it assigned by store/chain managers to their stores for selection by customers.

Customer Navigation: When a customer is browsing the store directory on the electronic kiosk 12, the coupon module provides the department/section navigation information to the kiosk module.

Coupon Availability: When the customer chooses a department/section to choose a coupon from, the coupon module will supply a list of coupons available for selection to the kiosk module.

Related Coupons: When the customer has finalized the coupon selection (by telling the electronic kiosk 12 to print the selected coupon(s), the coupon module will gather coupons from the same or related departments. If the related coupon search fails to return sufficient coupon value for the customer, select coupons randomly until sufficient value (e.g., 5-times purchase amount) has been reached.

Sweepstakes Generation Module: Each sweepstakes runs for a fixed period (normally 90 days) or while supplies last. Only a Sweepstakes Super Customer will have access to a Sweepstakes Administration Interface on the Sweepstake Generation Module. The Sweepstakes Super Customer is able to create coupon promotion, assign them to electronic kiosks 12, configure multi-location coupon promotions, check coupon promotion status (to calculate weekly, bi-weekly or monthly sweepstakes winnings checks for locations) and to generate reports.

Create Sweepstakes Function: The Sweepstakes Super Customer defines sets of sweepstakes rules that can be saved and assigned to kiosk locations. Once a sweepstakes has been assigned to any kiosk location, it cannot be modified (it would create problems with history reporting), so there is no Update Sweep function. Modified sweeps rules will require a new sweepstakes to be defined.

To create a sweepstake promotion, the Sweepstakes Super Customer will complete the activities listed in Table 1. However, the present invention is not limited to these activities listed in Table 1 and more, fewer or other activities can also be used to practice the invention.

TABLE 1

Set the number of sweepstakes entries
Set prize amounts for each level (there will at least six prize levels)
Set the number maximum number of days sweepstaeks completion
(default: 90 days)
Set the expiration date of winning tickets (default: 30 days past end
of sweepstakes)

As the Sweepstakes Super Customer defines a sweepstakes and defines prize sizes and number of winners, calculates prize total, prize percentage, total number of winners and percentage of winners on the fly to display on the screen.

Sweepstakes Identification: When a newly created sweepstakes is saved, it is codified it with a sweepstakes identifier “SweepiD” for identification. Codification is done using parameters that define the sweep. The encoded SweepID will be a unique index in the sweeps table is illustrated in Table 2. However, the present invention is not limited to these activities listed in Table 2 and more, fewer or other activities can also be used to practice the invention.

TABLE 2
Exemplary SweepID encoding system:

10K (pool size (number of entries) of 10,000)
25 W (percentage of winners, W25 on a 10 KP would mean 2500 winners)
46.8 P (prize percentage of pool, P46.8 on a 10 KP would mean $4680
in prizes)

With this encoding system, “10K25W46.8P” would be the identifier for the exemplary sweepstakes illustrated in Table 3. However, the present invention is not limited the exemplary sweepstakes and other sweepstakes can also be used to practice the invention.

TABLE 3
Sweepstakes Definition Worksheet

| | | | |
|---|---|---|---|
| Play | $1.00 | | |
| Entries | 10,000 | | |
| Prize Pool | $10,000 | | |
| Payout % | 46.80% | Payout$ | $4,680 |
| Winner % | 25.00% | #Winners | 2,500 |

| Prize | #Winners | $Payout | % Revenue | % Payout | % Players |
|---|---|---|---|---|---|
| $500 | 1 | $500 | 5.00% | 10.68% | 0.01% |
| $100 | 6 | $600 | 6.00% | 12.82% | 0.06% |
| $20 | 10 | $200 | 2.00% | 4.27% | 0.10% |
| $10 | 53 | $530 | 5.30% | 11.32% | 0.53% |
| $5 | 105 | $525 | 5.25% | 11.22% | 1.05% |
| $1 | 2325 | $2,325 | 23.25% | 49.68% | 23.25% |
| Total | 2500 | $4,680 | 46.80% | 100.00% | 25.00% |

Assigning Sweeps to Locations: Sweepstakes are assigned to electronic kiosk 12 locations. All electronic kiosks 12 at a location will be participating in the same sweepstakes that could be run from a server 30 at a location or from a remote sweepstakes server. Once a sweepstakes is assigned to a location, that location will continue to run iterations of those sweep rules until a new sweepstakes assignment is made. A sweep newly assigned to a kiosk does not begin until the sweep currently running on kiosk has completed normally. A log of sweepstakes assignments is maintained on the server 30 for report generation by a sweepstakes admin.

Sweepstakes Processing: When a sweepstakes is started at a location, the sweepstakes parameters assigned to it are checked and used to generate a sweep table. The number of entries and the number and value of each of the prizes are required to create the sweep.

Creating a Sweepstakes: To create a running sweepstakes, a table is generated that includes a row for each entry. Each row has four columns: “SweepEntryNum,” “PrizeAmount (initialized to zero),” “EntryAssigned,” (initialized to zero) and the “DateTime” it was assigned to an entrant. Winning numbers are randomly generated and prize values in the table are populated.

Every time a sweepstakes is created, it will be logged to a server 30 with information identifying the sweepstakes, location, start date, maximum end date, prize redemption expiration date. The actual end date for the sweepstakes will be logged when it occurs. To ensure smooth transition from one sweepstakes to the next, the table generation and population for the next sweepstakes should be done in a timely fashion in advance of completion of the current sweepstakes. This will allow a seamless transition from one sweepstakes to the next on consecutive transactions (or possibly even within a multi-coupon purchase transaction).

Generating a Sweep Entry: When a sweepstakes entry number is randomly generated, a table is checked for winner/loser. A table variable “EntryAssigned” is set for that number to True. If a sweepstakes entry number is generated for a number that has already been assigned, alternating increment/decrement (with rollover) are used until a non-assigned number is reached. That becomes the sweepstakes entry number for that participant. This method ensures that each number is selected only once and that a timestamp record is maintained for when each is selected. If all numbers are assigned before the sweepstakes expiration date, start a new sweepstakes. Winning numbers (w/amount and date) are stored for calculating totals, determining status and reporting.

When a customer has finalized coupon purchase (by directing the electronic kiosk 12 to print their coupons), a request for a sweepstakes entry will be made for each set of coupons purchased within the current transaction and is put in a queue for sweepstakes number generation. The sweepstakes number generator processes the transactions sequentially in the order that they occur. For API purposes, requests for sweepstakes entries will identify the coupon purchase transaction number and kiosk ID (with parameters range and error checked). The sweepstakes module sends a message to the coupon module to verify that the transaction is valid and it will send a message to the kiosk module to make sure that the kiosk is valid before issuing the sweepstakes entry to the kiosk for printing.

Sweep winning numbers are logged on the server 30 as they occur for reporting and payouts. Sweepstakes numbers printed on the ticket include alphanumeric information that identifies the sweep run, location and kiosk ID. The sweepstakes entry number are readable and bar-coded.

No Purchase Necessary ”Entry Processing: Customers may enter the sweepstakes without making a coupon purchase. The instructions for receiving a “no purchase necessary” sweepstakes entry will be displayed on the kiosk. Customers mail in an entry with their name, address, phone number and email address. The customer will include the store identifier to make a valid entry. The store identifier will be displayed with the no purchase necessary instructions.

Sweepstakes Redemption: Determining winners for sweepstakes entry redemption is done in two ways. For supermarket storefront and convenience store in-store kiosks, sweepstakes entries printed from the electronic kiosk 12 will show whether the entry is a winner or not and will display the prize value for redemption. For convenience store at-pump kiosks, the sweepstakes entry will print the sweepstakes entry number and a barcode of it. The customer will go in to the store to check the ticket by having the in-store kiosk read the bar code determine if it is a winner. For winners, a winning sweepstakes entry will be printed out for redemption.

Redemption expiration date for sweeps winners will be printed on the sweepstakes entry tickets. The date will be the maximum number of days for the sweep plus 30 (or as set in the sweep definition). Redemption is done at the location only, as register cash or as gift card. In one embodiment, a store sets the policy. In another embodiment, the store does not set the policy.

Kiosk Management Module: The Kiosk Management Module will allow for the configuration and monitoring of electronic kiosks.

Kiosk Management: The server includes a detailed database of all Coupon Sweeps/Coupon Road kiosks. Information related to the kiosk will be available for review, reporting and modification. Information maintained for kiosks include their address, including county and metro area designations, chain affiliations, hardware and software configuration, maintenance and sales history, and currently running sweepstakes. Supermarket storefront, convenience store in-store and convenience store at-pump kiosks will be represented as separate kiosk types.

Kiosk Monitoring and Remote Admin: The kiosk back-end management system requires features and functions of remote administration, monitoring and notification.

Ping for Status: The server will regularly ping each electronic kiosk 12 to confirm that it is up and all of its components are functioning properly. Date/time of last errorless ping is maintained for each kiosk. All error and warning conditions are logged.

Kiosk Verification: An Administrator is able to manually check an individual electronic kiosk 12 or all kiosks at a location via the communications network 28 by forcing a ping and receiving immediate detailed or summary status results for viewing.

Rebooting: Whenever an electronic kiosk 12 boots, it will send a message to the monitoring module with date/time/Ethernet address and any other information that might be useful for determining status and administering kiosks 12. A secure handshaking process will take place to ensure that only valid electronic kiosks 12 will gain access to the remote server 30.

Software Downloads: New versions of application or hardware drivers are download to electronic kiosks 12 via the communications networks. These software downloads can be used for attempting to recover from a problem or for routine software updates.

Alert Actions: Include creation of a hierarchy of classes/levels relating to problems and one or more actions to take. In the case of a failure being detected, an attempt is made to reset or restart components. If necessary, an electronic kiosk 12 is rebooted and recheck for status. Updated device drivers or software modules can be downloaded upon reboot.

Table 4 illustrates exemplary conditions and actions. However, the present invention is not limited to these conditions and actions listed in Table 4 and more, fewer or other activities can also be used to practice the invention.

TABLE 4

| Conditions | Actions |
|---|---|
| Paper low | notify store manager |
| Paper out. | notify store manager, display on screen w/status code |
| Bill acceptor full | notify store manager, display on screen w/status code |
| No network | notify store manager, check connections, cycle power |
| Peripheral failure | notify support, email or text to phone |

Reports Module: The reports module prints report data for electronic kiosks. Table 5 illustrates exemplary conditions and actions. However, the present invention is not limited to these conditions and actions listed in Table 5 and more, fewer or other activities can also be used to practice the invention.

TABLE 5
Electronic Kiosks 12

| | |
|---|---|
| A. | Coupons Purchased |

1. By location or sort
2. By chain
3. By CPM or sort
4. By product or sort
5. By type or sort
6. By non-purchased coupons
7. By date only
8. By transaction totals with averages for location/chains
9. Transaction split between cash and card for

| | location/chains |
|---|---|
| B. | Sweepstakes (Currently Running and Completed) |

1. By location
2. By chain
3. By type
4. By sweeps ID
5. By No Purchase Necessary
6. By date only
7. Payouts due by location/time period

| | |
|---|---|
| C. | Coupon Redemption |

1. By location or sort
2. By chain or sort
3. By CPM or sort
4. By product or sort
5. By type or sort
6. By non-purchased coupons
7. By date only

| | |
|---|---|
| D. | Maintenance Reports |

1. Downtime by location
2. Downtime by reason/duration

| | |
|---|---|
| i. | Temperature |
| ii. | Paper out |
| iii. | Paper jam |
| iv. | Power outage |
| v. | Software malfunction |
| vi. | Credit Card reader |
| vii. | Bill acceptor |
| viii. | Network Down |

Store/Chain Manager

| | |
|---|---|
| A. | Coupons Purchased |

1. By chain only
2. By location only
3. By CPM specific to chain or location
4. By product specific to chain or location
5. By type specific to chain or location
6. By date specific to chain or location

| | |
|---|---|
| B. | Sweepstakes |

1. By chain only on current sweeps
2. By location only on current sweeps

| | |
|---|---|
| C. | Coupon Redemption |

1. By location or sort
2. By CPM or sort
3. By product or sort
4. By type or sort
5. By date only

| | |
|---|---|
| D. | Maintenance Reports |

None needed

Product Manufacturer

| | |
|---|---|
| A. | Coupon Purchased |

1. By location or sort
2. By product or sort
3. By type or sort
4. By date

| | |
|---|---|
| B. | Sweepstakes |

1. None needed

| | |
|---|---|
| C. | Coupon Redemption |

1. By chain or sort
2. By location or sort
3. By product or sort
4. By type or sort
5. By date only

| | |
|---|---|
| D. | Maintenance Reports |

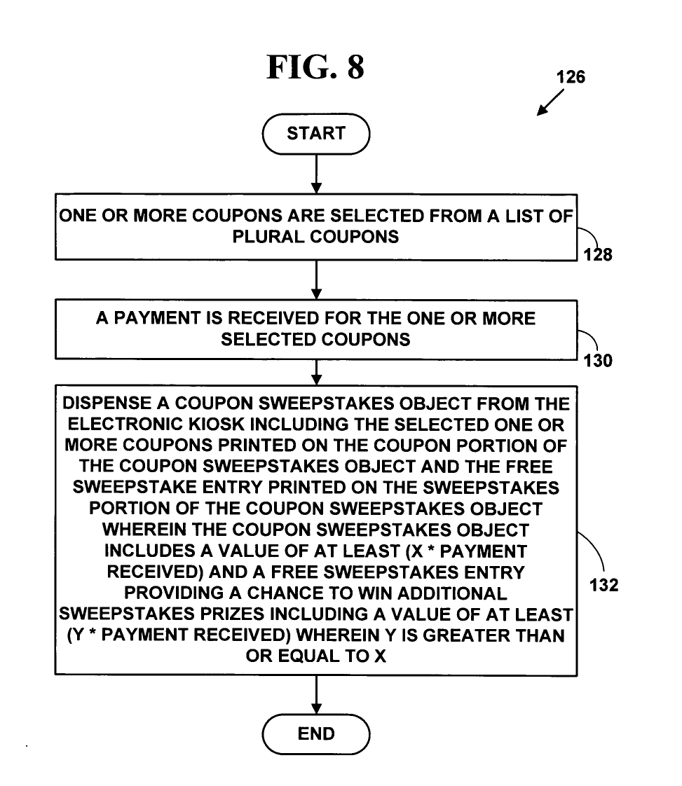

FIG. 8 is a flow diagram illustrating a Method 124 for providing a coupon sweepstakes object. At Step 126, one or more coupons are selected from a list of plural coupons. At Step 128, payment is received for the one or more selected coupons. At Step 130, a coupon sweepstakes object 32, 33 is dispensed from the electronic kiosk 12 including the selected one or more coupons printed on a coupon portion 36 of a coupon sweepstakes object 32, 33 and a free sweepstake entry printed on a sweepstakes portion 34 of the coupon sweepstakes object 32, 33, wherein the coupon sweepstakes object 32, 33 includes a value of at least (X*payment received) for the selected coupons and the free sweepstakes entry provides a chance to win additional sweepstakes prizes including a value of at least (Y*payment received) wherein Y is greater than or equal to X.

Method 124 is illustrated with an exemplary embodiment. However, the present invention is not limited to such an exemplary embodiment and other embodiments can also be used to practice the invention.

At Step 126, one or more coupons are selected from a list of plural coupons. In one embodiment, a customer selects the one or more coupons from the electronic kiosk in a store. In another embodiment, the customer selects the one or more coupons on a home computer or other network device via a network interface to the server 30 via the communications network 28. In another embodiment, the customer selects the one or more coupons from a remote access terminal that includes a card reader component. In such an embodiment, a list of the one or more coupons are stored on card such as a loyalty card, retail card, or store card that is readable by the card reader component 18 on the electronic kiosk.

At Step 128, payment is received for the one or more selected coupons. In one embodiment, payment is received by the card reader component 18 or the current input component 20 on the electronic kiosk 12. In another embodiment, the payment is received via a home computer or other network device via a network interface to the server 30 via the communications network 28.

Step 130, a coupon sweepstakes object 32, 33 is dispensed from the electronic kiosk 12 including the selected one or more coupons printed on a coupon portion 36 of a coupon sweepstakes object 32, 33 and a free sweepstake entry printed on a sweepstakes portion 34 of the coupon sweepstakes object 32, 33, wherein the coupon sweepstakes object 32, 33 includes a value of at least (X*payment received) for the selected coupons and the free sweepstakes entry provides a chance to win additional sweepstakes prizes including a value of at least (Y*payment received) wherein Y is greater than or equal to X.

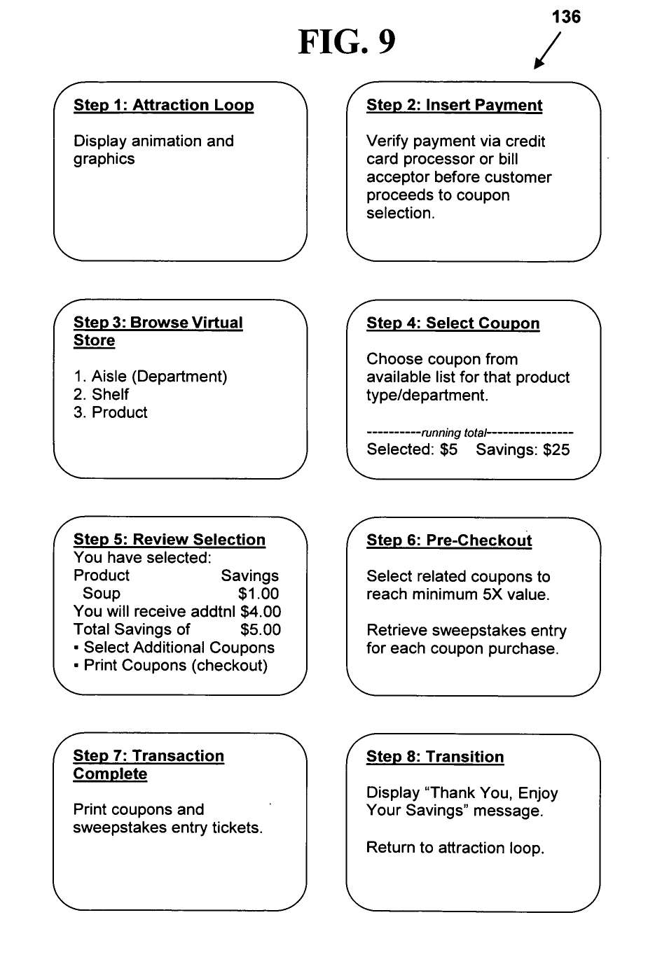

FIG. 9 is a block diagram illustrating exemplary data flow 132 for the electronic kiosk 12.

It should be understood that the architecture, programs, processes, methods and systems described herein are not related or limited to any particular type of computer or network system (hardware or software), unless indicated otherwise. Various types of general purpose or specialized computer systems may be used with or perform operations in accordance with the teachings described herein.

In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more or fewer elements may be used in the block diagrams.

While various elements of the preferred embodiments have been described as being implemented in software, in other embodiments hardware or firmware implementations may alternatively be used, and vice-versa.

The claims should not be read as limited to the described order or elements unless stated to that effect. In addition, use of the term “means” in any claim is intended to invoke 35 U.S.C. §112, paragraph 6, and any claim without the word “means” is not so intended.

Therefore, all embodiments that come within the scope and spirit of the following claims and equivalents thereto are claimed as the invention.

We claim:

1. A coupon and sweepstakes dispensing system, comprising in combination:
an electronic kiosk component including:
a customer attraction component for attracting customers to the electronic kiosk;
a touch screen component for selecting a plurality of coupons;
a card reader component for accepting cards with magnetic, optical, alphanumeric or radio frequency identifier (RFID) readable information for a purchase price for the selected plurality of coupons;
a currency input component for accepting currency for a purchase price for the selected plurality of coupons;
a coupon and sweepstakes printing and dispensing component for printing and dispensing a plurality of selected coupons and a sweepstakes entry on a coupon sweepstakes object, wherein the coupon sweepstakes object includes a plurality of selected coupons with a redemption value N-times greater than a purchase price for the selected plurality of coupons and a free sweepstakes entry with a potential winning redemption value M-times greater than the purchase price of the plurality of selected coupons, where M is greater than N; and
a network interface component for connecting the electronic kiosk to a communications network including one or more servers.

2. The coupon sweepstakes dispensing system of claim 1 wherein the electronic kiosk includes a supermarket storefront kiosk.

3. The coupon sweepstakes dispensing system of claim 1 wherein the electronic kiosk includes a convenience store at-pump kiosk.

4. The coupon sweepstakes dispensing system of claim 1 wherein the electronic kiosk includes a convenience store in-store kiosk.

6. The coupon sweepstakes dispensing system of claim 1 wherein the redemption value for the selected plurality of coupons printed on the coupon sweepstakes objects is at least five-times the purchase price for the selected plurality of coupons.

7. The coupon sweepstakes dispensing system of claim 1 wherein the card reader component accepts credit, debit, gift, retail or store loyalty cards.

8. A coupon and sweepstakes object, comprising in combination:
a sweepstakes portion for a free sweepstakes entry including a sweepstakes serial number a sweepstakes security identifier, sweepstakes identifier and a winner identifier including an amount won or loser identifier; and
a coupon portion for a plurality of purchased coupons including coupon information for one or more selected products or services including, date and time information, plurality of including coupons including coupon information comprising, a coupon redemption value and manufacturer identifier information,
wherein the selected plurality of selected coupons include a redemption value N-times greater than a purchase price for the selected plurality of coupons and a free sweepstakes entry with a potential winning redemption value M-times greater than the purchase price of the plurality of selected coupons, where M is greater than N.

9. The coupon and sweepstakes object of claim 8, wherein the coupon sweepstakes objects includes a size of at least 2.5 inches by 6 inches, with a preferred size of at least 3 inches by 6 inches.

10. A method for providing a coupon sweepstakes object, comprising:
receiving a selection input on an electronic kiosk for a coupon sweepstakes object;
automatically retrieving a plurality of coupons purchased and selected from a list of available coupons to be printed on a coupon portion of a coupon sweepstakes object;
automatically retrieving a free sweepstakes entry randomly generated to be printed on a sweepstake portion of the coupon sweepstakes object;
dispensing a coupon sweepstakes object from the electronic kiosk in response to the selection input including the retrieved plurality of coupons printed on the coupon portion of the coupon sweepstakes object and the retrieved free sweepstake entry printed on the sweepstakes portion of the coupon sweepstakes object.

11. The method of claim 10 further comprising a computer readable medium having stored therein for one or more processor to execute the steps of the method.

12. The method of claim 10 wherein the step of automatically retrieving a plurality of coupons includes automatically and securely retrieving a plurality of coupons from an external server via a communications network.

13. The method of claim 10 wherein the step of automatically retrieving a plurality of coupons includes automatically retrieving a plurality of coupons from an internal computer readable medium in the electronic kiosk.

14. The method of claim 10 wherein the step of automatically retrieving a free sweepstakes entry includes automatically and securely retrieving a free sweepstake entry from an external server via a communications network.

15. The method of claim 10 wherein the step of automatically retrieving a free sweepstakes entry includes automatically and securely retrieving a free sweepstake entry from an internal computer readable medium in the electronic kiosk.

16. The method of claim 10 wherein coupon sweepstakes object wherein the retrieved plurality of coupons printed on the coupon portion include a redemption value N-times greater than a purchase price for the selected plurality of coupons and the retrieved sweepstake entry printed on the sweepstakes portion includes a potential winning redemption value M-times greater than the purchase price of the plurality of selected coupons, where M is greater than N.

17. A method for providing a coupon sweepstakes object, comprising:
receiving a selection input on an electronic kiosk for a coupon sweepstakes object, wherein the selection input includes receipt of a payment of $nn.nn;
automatically retrieving one or more coupons from a list of available coupons to be printed on a coupon portion of the coupon sweepstakes object, wherein the one or more coupons include a value of at least (X*$nn.nn);
automatically retrieving a free sweepstakes entry to be printed on a sweepstake portion of the coupon sweepstakes object, wherein the free sweepstakes entry provides a chance to win additional sweepstakes prizes including a value of at least (Y*$nn.nn) wherein Y is greater than or equal to X; and
dispensing a coupon sweepstakes object from the electronic kiosk in response to the selection input including the selected one or more coupons printed on the coupon portion of the coupon sweepstakes object and the free sweepstake entry printed on the sweepstakes portion of the coupon sweepstakes object, wherein the coupon sweepstakes object includes a coupon value of at least (X*$nn.nn) received via the selection input and the free sweepstakes entry providing a chance to win additional sweepstakes prizes including a value of at least (Y*$nn.nn), wherein Y is greater than or equal to X.

18. The method of claim 17 further comprising a computer readable medium having stored therein for one or more processor to execute the steps of the method.

19. A coupon and sweepstakes dispensing system, comprising in combination:
a kiosk module for managing an electronic kiosk;
an attraction loop module for attracting customers to the electronic kiosk;
a transaction processing module for processing payments accepted for one or more coupons purchased by a customer;
coupon selection module for selecting one or more available coupons;
sweepstakes entry module for requesting a free sweepstakes entry;
sweepstakes entry verification module for verifying a validity of the free sweepstakes entry;
configuration and monitoring module for monitoring the electronic kiosk;
a coupon generation module for generating one or more selected coupons;
sweepstakes generation module for generating a free sweepstakes entry;
kiosk management module for managing other module on the electronic kiosk; and
a reports module for printing reports.

20. A method for providing a coupon sweepstakes object, comprising:
selecting one or more coupons from a list of a plurality coupons;
receiving payment for the one or more selected coupons on an electronic kiosk;
dispensing from the electronic kiosk the selected one or more coupons printed on the coupon portion of a coupon sweepstakes object and a free sweepstake entry printed on a sweepstakes portion of the coupon sweepstakes object,
wherein the coupon sweepstakes object includes a value of at least (X*payment received) for the one or more coupons and the free sweepstakes entry provides a chance to win additional sweepstakes prizes including a value of at least (Y*payment received) wherein Y is greater than or equal to X.

21. The method of claim 20 further comprising a computer readable medium having stored therein for one or more processor to execute the steps of the method.

22. The method of claim 20 wherein the step of selecting one or more coupons includes selecting the one or more coupons from the electronic kiosk in a store.

23. The method of claim 20 wherein the step of selecting one or more coupons includes selecting the one or more coupons from a network interface on a server including a virtual electronic kiosk via a communications network.

24. The method of claim 20 wherein the step of selecting one or more coupons includes:
selecting the one or more coupons from a remote access terminal that includes a card reader component; and
storing a list of the one or more coupons on a card such as a loyalty card, retail card, or store card or on a customer profile stored on a sever that is readable by the electronic kiosk.

25. A coupon and sweepstakes dispensing system, comprising in combination:
means for attracting customers to an electronic kiosk;
means for selecting a plurality of coupons;
means for accepting cards with magnetic, optical, alphanumeric or radio frequency identifier (RFID) readable information for a purchase price for the selected plurality of coupons;
means for accepting currency for a purchase price for the selected plurality of coupons;
means for printing and dispensing a plurality of selected coupons and a sweepstakes entry on a coupon sweepstakes object, wherein the coupon sweepstakes object includes a plurality of selected coupons with a redemption value N-times greater than a purchase price for the selected plurality of coupons and a free sweepstakes entry with a potential winning redemption value M-times greater than the purchase price of the plurality of selected coupons, where M is greater than N; and
means for connecting the electronic kiosk to a communications network including one or more servers.
